(19) United States
(12) Patent Application Publication
(10) Pub. No.: US 2022/0093375 A1
(43) Pub. Date: Mar. 24, 2022

(54) System Including Thermal Energy Harvesting Thermionic Device and Appliance, and Related Methods

(71) Applicant: Birmingham Technologies, Inc., Arlington, VA (US)

(72) Inventor: Joseph Birmingham, Arlington, VA (US)

(73) Assignee: Birmingham Technologies, Inc., Arlington, VA (US)

(21) Appl. No.: 17/024,807

(22) Filed: Sep. 18, 2020

(51) Int. Cl. H01J 45/00; H02J 7/00; H02J 7/34

(52) U.S. Cl. CPC H01J 45/00; H02J 2207/50; H02J 7/345; H02J 7/0045

(57) ABSTRACT

Embodiments relate to an apparatus including an appliance adapted to generate thermal energy, a thermal energy harvesting thermionic device proximal to the appliance to receive the thermal energy from the appliance and generate an electrical output, an electrical conductive path configured to transfer electrical output from the thermal energy harvesting thermionic device to a load, and a heat dissipating device positioned with respect to the thermal energy harvesting thermionic device to reduce a temperature of the electrical conductive path by thermal exchange. The thermal energy harvesting thermionic device includes a cathode, an anode spaced from the cathode, and a plurality of nanoparticles in a medium contained in the space between the cathode and the anode. The nanoparticles are configured to permit electron transfer between the cathode and the anode.

### BACKGROUND

The present embodiments relate to a system including a thermal energy harvesting thermionic device operatively coupled to or adapted to be operatively coupled to an appliance. Also provided are related systems and methods, including methods of making and using the system.

Existing electrochemical technologies, such as lithium-ion, lead-acid, and nickel-cadmium battery technology, have performance limitations and are burdened by limited operational durations due to limited energy storage. Further, existing electrochemical technologies include hazardous material subject to sometimes onerous handling, shipping, and disposal requirements. Furthermore, electrochemical technologies are also constrained by battery service and shelf-life limitations, particularly caused by electrochemical degradation under mechanical stress, and charge and discharge rates that limit operational lifetime.

### SUMMARY

The embodiments include systems, apparatus, and methods that include a thermal energy harvesting thermionic device operatively coupled to or adapted to be operatively coupled to an appliance.

In an aspect, a system is provided that includes an appliance adapted to generate thermal energy, a thermal energy harvesting thermionic device positioned proximal to the appliance to receive thermal energy from the appliance and generate an electrical output, an electrical conductive path configured to transfer electrical output from the thermal energy harvesting thermionic device to a load, and a heat-dissipating device positioned to reduce a temperature of the electrical conductive path by thermal exchange. The thermal energy harvesting thermionic device includes a cathode, an anode spaced from the cathode, and a plurality of nanoparticles in a medium contained in the space between the cathode and the anode. The nanoparticles are configured to permit electron transfer between the cathode and the anode.

In another aspect, a method is provided that includes providing a system including an appliance adapted to generate thermal energy, a thermal energy harvesting thermionic device positioned proximal to the appliance to receive thermal energy from the appliance and generate an electrical output, an electrical conductive path configured to transfer electrical output from the thermal energy harvesting thermionic device to a load, and a heat-dissipating device positioned to reduce a temperature of the electrical conductive path by thermal exchange. The thermal energy harvesting thermionic device includes a cathode, an anode spaced from the cathode, and a plurality of nanoparticles in a medium contained in the space between the cathode and the anode. The nanoparticles are configured to permit electron transfer between the cathode and the anode. According to the embodied method, the appliance generates thermal energy, which is transferred to the thermal energy harvesting thermionic device to generate the electrical output, which may be used to power the load. The temperature of the electrical conductive path is reduced using the heat-dissipating device.

In yet another aspect, a system is provided that includes an appliance comprising a housing and a heat source contained within the housing and adapted to generate thermal energy, a thermal energy harvesting thermionic device positioned within the housing of the appliance to receive the thermal energy from the appliance and generate an electrical output, an electrical conductive path configured to transfer electrical output from the thermal energy harvesting thermionic device to the appliance to power the appliance, and a heat-dissipating device positioned to reduce a temperature of the electrical conductive path by thermal exchange. The thermal energy harvesting thermionic device includes a cathode, an anode spaced from the cathode, and a plurality of nanoparticles in a medium contained in the space between the cathode and the anode. The nanoparticles are configured to permit electron transfer between the cathode and the anode.

In still another aspect, a method is provided that includes providing a system including an appliance adapted to generate thermal energy, a thermal energy harvesting thermionic device positioned within a housing of the appliance to receive thermal energy from a heat source within the housing of the appliance and generate an electrical output, an electrical conductive path configured to transfer electrical output from the thermal energy harvesting thermionic device to the appliance, and a heat-dissipating device positioned to reduce a temperature of the electrical conductive path by thermal exchange. The thermal energy harvesting thermionic device includes a cathode, an anode spaced from the cathode, and a plurality of nanoparticles suspended in a medium contained in the space between the cathode and the anode. The nanoparticles are configured to permit electron transfer between the cathode and the anode. According to the embodied method, the appliance generates thermal energy, which is transferred to the thermal energy harvesting thermionic device to generate the electrical output. The appliance is operatively connected to the thermal energy harvesting thermionic device to receive the electrical output from the thermal energy harvesting thermionic device for powering the appliance.

In a further aspect, a portable apparatus is provided that includes a portable housing, and an electrical energy storage device, a heat-generating source, and a thermal energy harvesting thermionic device within the housing. The housing includes at least one male electrical coupling member and at least one female electrical coupling member. The heat-generating source is operatively connected to the electrical energy storage device to convert electrical energy supplied by the electrical energy storage device to heat. The thermal energy harvesting thermionic device is proximal to the heat generating source to receive the thermal output from the heat-generating source and generate an electrical output. The thermal energy harvesting thermionic device is electrically connected to the at least one female electrical coupling member to provide the electrical output to the at least one female electrical coupling member. The thermal energy harvesting thermionic device includes a cathode, an anode spaced from the cathode, and a plurality of nanoparticles suspended in a medium contained in the space between the cathode and the anode. The nanoparticles are configured to permit electron transfer between the cathode and the anode.

In still a further aspect, a method is provided that includes providing a portable apparatus including a portable housing, and an electrical energy storage device, a heat-generating source, and a thermal energy harvesting thermionic device within the housing. The housing includes at least one male electrical coupling member and at least one female electrical coupling member. The heat-generating source is operatively connected to the electrical energy storage device to convert electrical energy supplied by the electrical energy storage device to thermal output. The thermal energy harvesting thermionic device is positioned proximal to the heat-generating source to receive the thermal output from the heat-generating source and to generate an electrical output. The thermal energy harvesting thermionic device is electrically connected to the at least one female electrical coupling member. The thermal energy harvesting thermionic device includes a cathode, an anode spaced from the cathode, and a plurality of nanoparticles suspended in a medium contained in the space between the cathode and the anode. The nanoparticles are configured to permit electron transfer between the cathode and the anode. According to an embodiment, the at least one male electrical coupling member of the portable apparatus is electrically coupled to an electrical power source to charge the electrical energy storage device. The at least one male electrical coupling member is electrically uncoupled from the electrical power source. The at least one female electrical coupling member is electrically coupled to an appliance. Electrical energy from the electrical energy storage device is supplied to the heat-generating source to generate thermal output, which is used by the thermal energy harvesting thermionic device to generate electrical output. The electrical output is supplied to the appliance electrically coupled to the at least one female electrical coupling member to operate the appliance.

Other aspects disclosed herein include systems, devices, components, apparatus, methods, and processes. Features of these and other aspects will become apparent from the following detailed description of exemplary embodiments, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments, and not of all embodiments, unless otherwise explicitly indicated.

FIG. 1 depicts a block diagram of an apparatus or system including a thermal energy harvesting thermionic device, an appliance, and a heat dissipating device according to an exemplary embodiment.

FIG. 2 depicts a block diagram of an apparatus or system including a thermal energy harvesting thermionic device, an appliance, and a heat dissipating device according to another exemplary embodiment.

FIG. 3 depicts a block diagram of an apparatus or system including a thermal energy harvesting thermionic device, an appliance, and a heat dissipating device according to a further exemplary embodiment.

FIG. 4 depicts a block diagram of an apparatus or system including a thermal energy harvesting thermionic device, an appliance, and a heat dissipating device according to still another exemplary embodiment.

FIG. 5A depicts a perspective view of an apparatus or system including a thermal energy harvesting thermionic device adapted for coupling to an appliance according to a further exemplary embodiment.

FIG. 5B depicts a schematic diagram for the apparatus or system of FIG. 5A.

FIG. 5C depicts an alternative schematic diagram for the apparatus or system of FIG. 5A.

FIG. 6A depicts a fragmented side perspective view and FIG. 6B depicts a cross-sectional view taken along sectional line 6B-6B of FIG. 6A of a heat-dissipating device according to an exemplary embodiment.

FIG. 7 depicts a sectional view of a thermal energy harvesting thermionic device according to an exemplary embodiment.

FIG. 8A depicts a transparent top view of an embodiment of a spacer and adjacent electrodes for use in a thermal energy harvesting thermionic device.

FIG. 8B depicts a transparent top view of an embodiment of a spacer and adjacent electrodes for use in a thermal energy harvesting thermionic device.

FIG. 9 depicts a schematic view of an embodiment of a nano-fluid of a thermal energy harvesting thermionic device, the nano-fluid including a plurality of nanoparticle clusters suspended in a dielectric medium.

FIG. 10 depicts a schematic perspective view of a circuit containing a thermal energy harvesting thermionic device, an electrical load or a re-chargeable power storage device, and a heat dissipating device.

FIG. 11 depicts a perspective view of a thermal energy harvesting thermionic device according to an embodiment.

FIG. 12 depicts a perspective view of a first repository of layered materials that may be used to manufacture a thermal energy harvesting thermionic device.

FIG. 13 depicts a perspective view of a second repository of layered materials that may be used to manufacture a thermal energy harvesting thermionic device.

FIG. 14A depicts an enlarged perspective, sectional and fragmented view of a portion of the thermal energy harvesting thermionic device of FIG. 11.

FIG. 14B is a fragmented cross-sectional view of box 14B of FIG. 14A depicting part of the thermal energy harvesting thermionic device of FIG. 11.

FIG. 15 is a cross-sectional view of a multi-layer thermal energy harvesting thermionic device according to an exemplary embodiment.

FIG. 16 depicts a flowchart illustrating a process for generating electrical power with a thermal energy harvesting thermionic device and operating the apparatus.

FIG. 17 depicts an electrospray technique suitable for making a thermal energy harvesting thermionic device according to exemplary embodiments.

FIG. 18 depicts an appliance, specifically a toaster, incorporating a thermal energy harvesting thermionic device according to an exemplary embodiment.

FIG. 19 is a schematic diagram of a charging circuit according to an embodiment.

### DETAILED DESCRIPTION OF EXEMPLARY EMBODIMENTS

It will be readily understood that the components and features of the exemplary embodiments, as generally described herein and illustrated in the Figures, may be arranged and designed in a wide variety of different configurations. Thus, the following detailed description of the embodiments of the methods, devices, assemblies, apparatus, systems, compositions, etc. of the exemplary embodiments, as presented in the Figures, is not intended to limit the scope of the embodiments, as claimed, but is merely representative of selected embodiments.

The illustrated embodiments will be best understood by reference to the drawings, wherein like parts are designated by like numerals throughout. The following description is intended only by way of example, and illustrates certain selected embodiments of methods, devices, assemblies, apparatus, systems, etc. that are consistent with the embodiments as claimed herein.

Reference throughout this specification to “a select embodiment,” “one embodiment,” “an exemplary embodiment,” or “an embodiment” means that a particular feature, structure, or characteristic described in connection with the embodiment is included in at least one embodiment. Thus, appearances of the phrases “in a select embodiment,” “in one embodiment,” “in an exemplary embodiment,” or “in an embodiment” in various places throughout this specification are not necessarily referring to the same embodiment. The embodiments may be combined with one another in various combinations and modified to include features of one another.

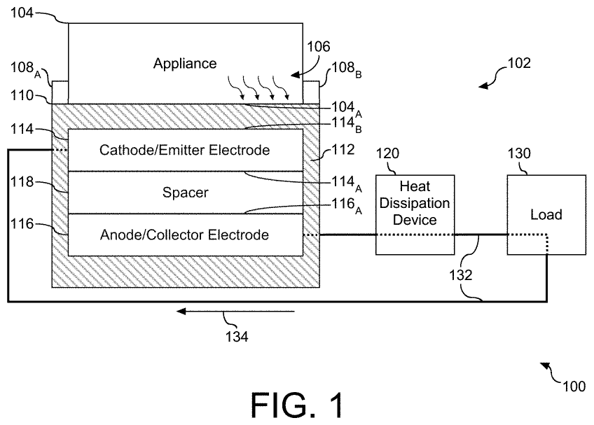

Referring now more particularly to FIG. 1, a block diagram (100) depicts an apparatus or system (102) for powering a load (130). The load (130) can be, by way of example, a power-consuming device, including but not limited to an appliance. In another embodiment, the load (130) can be a rechargeable battery or secondary cell, a capacitor, etc., which may be provided either internal or external to a power-consuming device.

The system (102) includes an appliance (104), a thermal energy harvesting thermionic device, generally designated by reference numeral (110), a heat dissipation device (also referred to herein as a heat dissipater) (120), and an electrical conductive path (132) including one or more electrical conductors. Portions of the electrical conductive path (132) connected to or passing through parts or components, such as the heat dissipation device (120), load (130), and walls of a housing (112) of the thermionic device (110), are sometimes shown as broken or dashed lines passing through the parts or components. The one or more electrical conductors can be, for example, one or solid electricity-conveying members such as wires, traces, electrical ink, electrical lines, etc.

Appliance (104)

The appliance (104) is a power-consuming device that during operation generates thermal energy (or heat). The appliance (104) may be in the form of a physical device, apparatus, machine, or equipment configured for use in a commercial or domestic domain. In an exemplary embodiment, the appliance (104) is electrically or at least partially electrically operated. With respect to the domestic domain, the appliance (104) may be, but not limited to, electrically operated for use in the home or for performance of domestic chores. Examples of appliances (104) include, without limitation, refrigerators, freezers, washing machines, dryers, dishwashers, ranges, ovens, stoves, microwaves, toasters, mixers, vacuums, air conditioners, air purifiers, garbage disposals, trash compacters, water heaters, etc. In an embodiment, the appliance (104) may be in the form of a portable electrically operated device, apparatus, or machine, such as but not limited to a mobile telephone, e.g., cellphone, tablet computer, laptop computer, watch, etc. Most electrical appliances are designed to operate using either alternating current (e.g., a utility grid connected to a wall outlet) or direct current (e.g., an electrochemical battery) sources. Batteries, for example, may be internal or external to the appliance, and may be rechargeable or replaceable.

Appliances, whether residential, domestic or commercial, generate thermal energy in one or more of a number of ways, including through the use of resistors or as a by-product of power production, e.g., heat generated by the operation of a motor or compressor or other operative mechanism of the appliance.

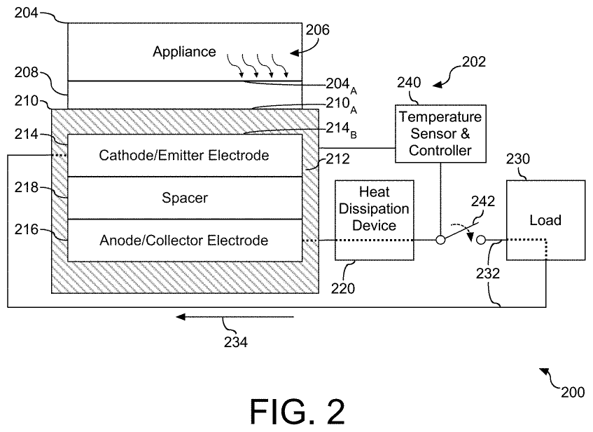

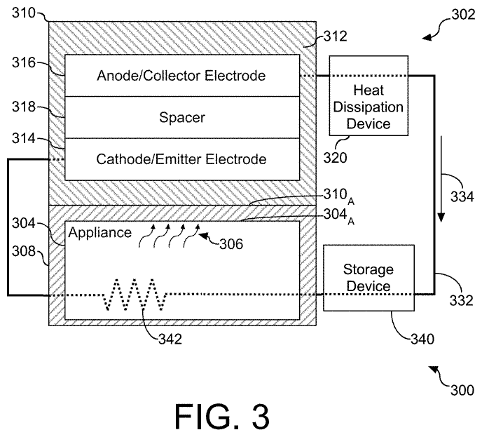

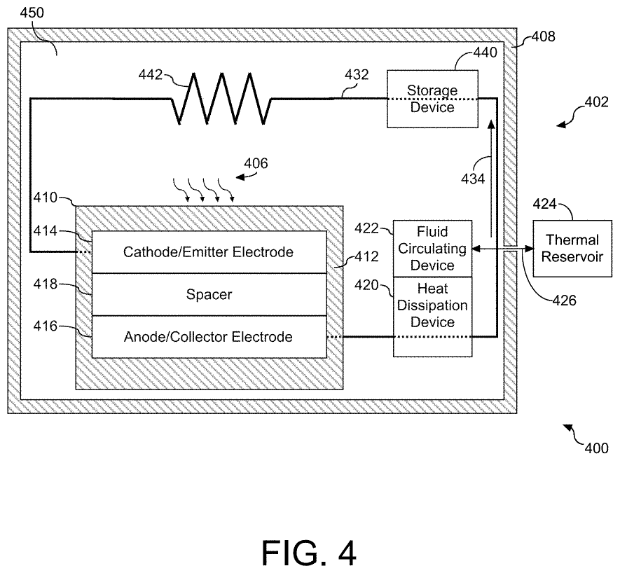

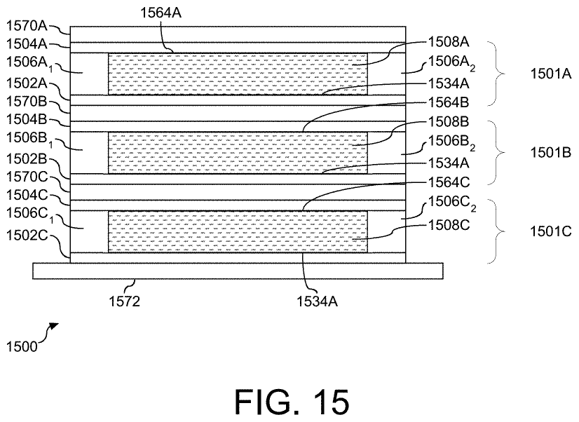

As discussed in further detail below, the thermal energy harvesting thermionic device (110) is positioned proximal to (e.g., below, on, next to) the appliance (104) to both cool the appliance (104) by drawing heat away from the appliance (104) and to synergistically generate power. In FIG. 1, the appliance (104) is connected or positioned adjacent to a thermal energy harvesting thermionic device (110). In the example shown herein, the appliance is secured to the thermal energy harvesting thermionic device (110) using one or more mechanical fasteners (108_{A}) and (108_{B}). Alternatively or in addition to the use of fasteners, the thermionic device (110) may be adhered to the appliance (104) with an adhesive or adhesive layer, such as the adhesive layer (208), as shown in FIG. 2 and discussed below. Alternatively, the thermionic device (110) may be printed directly on the appliance (104), as shown in FIG. 3, discussed below. In another alternative depicted in FIG. 4, discussed below, the thermionic device (110) may be incorporated into the housing of the appliance (104). In an exemplary, non-limiting embodiment, the thermionic device (110) is a compiled nanoscale energy harvester (e.g., a plurality of connected harvester cells), an example of which is depicted in FIG. 15.

Thermal Energy Harvesting Thermionic Device (110)

As shown in FIG. 1, the thermal energy harvesting thermionic device (110) is positioned proximal to, and in an embodiment adjacent to, and in another embodiment abutting against, the appliance (104) to receive heat or thermal energy by-product (106) from the appliance (104) and generate an electrical output, in particular electricity. The thermal energy harvesting thermionic device (110) includes at least a cathode (114), an anode (116) spaced from the cathode (114) to provide an inter-electrode space (also referred to herein as a gap) (118) between the cathode (114) and the anode (116), and a fluid contained in the inter-electrode gap (118). In exemplary embodiments, the fluid is a nano-fluid comprising a plurality of nanoparticles suspended in a fluid medium. The nanoparticles are situated in the inter-electrode gap (118) to permit electron transfer between the cathode (114) and the anode (116).

A housing (112) is provided to enclose the cathode (114), the anode (116), and the nano-fluid in the inter-electrode gap (118). According to an exemplary embodiment, the housing (112) is made of an aerogel material. However, the housing (112) may be made of other materials, whether conductive, semi-conductive, or insulating. Representative materials include metals, alloys, plastics, glass, etc.

The thermal energy harvesting thermionic device (110) operates on a thermionic power conversion principle to convert thermal energy (106) supplied by the appliance (104) into electrical energy (electricity) by an emission of electrons from the cathode (114), which is also referred to herein as an emitter electrode. The production of electrons from the cathode (114) is controlled by barriers to the flow of electricity. The first barrier to be overcome involves establishing electron energy that is sufficiently large to exceed the work function of the cathode (114) to enable electron emission from a surface of the cathode (114), such as the first surface (114_{A}) of the cathode (114). At lower temperatures, only a fraction of the electrons have sufficient energy to allow thermionic emission to proceed, thus limiting current flow. Intermediate and elevated temperatures provide higher energy than lower temperatures, with the intermediate temperatures giving rise to an increase in electron production at the cathode surface (114_{A}) of the cathode (114) due to an increased or larger distribution of electrons with the required energy for emission. As kinetic energy of the electrons is dependent upon the temperature of the cathode (114), increasing the temperature of the cathode (114) results in an increase in electron emission, and hence electrical current.

The electrons emitted from the cathode (114) cool the cathode (114) in a similar way that rain evaporating from roof carries away heat. The “hot” electrons emitted by the cathode (114) pass through the nano-fluid in the inter-electrode gap (118) and heat the anode (116), which is also referred to herein as a collector electrode. This movement of electrons sets up a thermal gradient for a nanoscale heat engine.

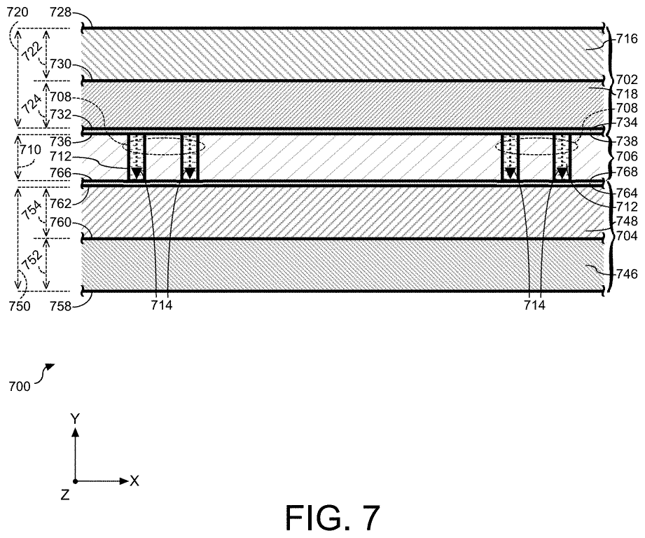

Electrons flow from the cathode/emitter electrode (114), across the nano-fluid in the inter-electrode gap (118), to the anode/collector electrode (116). As shown, the anode (116) is spaced from the cathode (114) by the inter-electrode gap (118), as shown and described in FIG. 7. As mentioned above, a medium is contained in the inter-electrode gap (118). The medium is in contact with facing surfaces (114_{A}) and (116_{A}) of the cathode (114) and the anode (116), respectively. According to an exemplary embodiment, the medium contains suspended nanoparticles to permit electron transfer between the cathode (114) and the anode (116). Thermal processes which involve the transport of the electrons across the electrode gap (118) (without, or in an embodiment with minimal, resistively heating the nano-fluid) involve movement of nanoparticles within the medium in the inter-electrode gap (118) to come close together or collide with each other and with the facing surfaces (114_{A}) and (116_{A}) of the electrodes (114) and (116), respectively. These collisions enable the hopping or transition of electrons in the direction of the electric field (i.e., current production). A reverse production of electrons from the anode (116) to the cathode (114) is suppressed by the electric field. In an embodiment, the electric field is supplied by the use of dissimilar electrode materials, e.g. metals, graphene, etc. The transmission of the electrons across the gap from the cathode (114) (emitter electrode) to the collector (116) (anode electrode) creates a flow of electrical energy, and when connected to a circuit, enables electrons to pass through an electrical load completing the circuit. Although not shown in the accompanying drawings, electrical current from the thermal energy harvesting thermionic device (110) to the load (130) via the electrical conductive path (132) may be smoothed via, for example, a trimming capacitor.

Recent improvements in thermionic power converters pertain to material selection based on work functions and corresponding work function values for the electrodes and using a fluid to fill the inter-electrode gap. Electron transfer density is limited by the materials of the electrodes and the materials of the fluid in the inter-electrode gap (i.e., the associated work functions). Representative and exemplary materials, features, conditions, etc. associated with thermal energy harvesting thermionic devices are described in further detail below, including in connection with FIGS. 7-15.

As noted, thermal energy causes electrons to flow from the cathode (114) to the anode (116). Accordingly, the appliance (104) is placed in closer proximity to the cathode (114) than the anode (116) of the thermal energy harvesting thermionic device (110) in an exemplary embodiment. As shown in the example of FIG. 1, the appliance (104) is placed adjacent to the cathode (114) via the mechanical fasteners (108_{A}) and (108_{B}) that maintain a surface (104_{A}) of the appliance (104) proximal to a surface (114_{B}) of the cathode (114), and as shown in FIG. 1 directly abutting against or directly in communication with the thermionic device housing (112).

While in exemplary embodiments described above, the thermal energy harvesting thermionic device (110) harvests thermal energy from the appliance (104), in exemplary embodiments the thermionic device (110) also harvests ambient heat from air and uses the ambient heat to generate additional electricity. Additionally, although not shown in FIG. 1, excess electricity may be stored in a capacitor or other energy storage device to meet varying demands for power. The capacitor or other energy storage device may be positioned within or external to the appliance (104), shown by way of example in FIG. 3.

Heat Dissipation/Heat Dissipation Device (120)

According to an exemplary embodiment, a design feature of an exemplary embodiment of the circuit is that the size, e.g., diameter, of the return wire or other electrical conductive path(s)/connector(s) (132) is small enough to transfer heat readily back to the cathode (114) without creating a large resistance. The temperature or average energy of electrons is reduced due to thermal exchange of heat leaving the anode (116) to a heat dissipation device (also referred to and embodied herein as a heat dissipating device) (120), such as a heat exchanger or a heat sink. The electron flow with a reduced thermal energy is delivered to the load (130), thereby reducing the likelihood that the load (130) will overheat. The electrons then flow back to the cathode (114) to maintain the thermionic device operating at a high efficiency. In an exemplary embodiment, the heat-dissipation device (120) is a microstructure array heat exchanger. Implementation of the heat dissipating device (120) functions to reduce an average energy of electrons leaving the anode (116). Returning electrons that are re-supplied to the cathode/emitter electrode (114) will therefore complete a heat engine cycle with a lower average energy leaving an operatively coupled load (130) than supplied to the load.

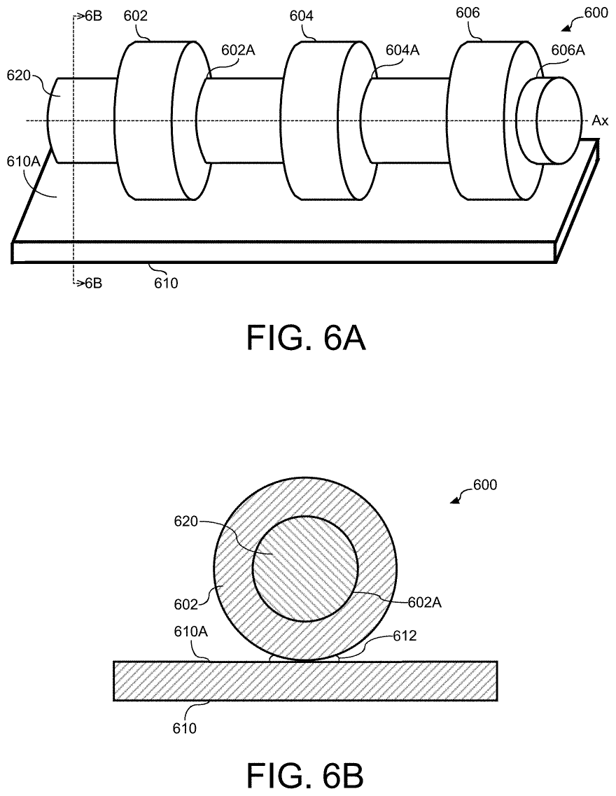

The heat-dissipation device (120) may be embodied as, for example, a heat sink or a heat exchanger. In an exemplary embodiment, the heat-dissipation device (120) comprises a micro-structure array heat exchanger. Referring to FIGS. 6A and 6B, an embodiment of a heat-dissipating device is generally designated by reference numeral (600) positioned with respect to the conductive path (132), embodied in FIGS. 6A and 6B as an electrical conductor (620), such as a wire, having a central longitudinal axis Aₓ. In FIG. 6A, the electrical conductor (620) is shown continuous in length and fragmented at opposite ends, such that the electrical conductor (620) may be proportionally longer than illustrated.

The heat-dissipation device (600) includes a plurality of rings, annular fins, or arcuate surfaces, hereinafter referred to as annular fins, and illustrated as first, second, and third annular fins (602), (604), and (606), respectively. Although three annular fins (602), (604), and (606) are shown in FIG. 6A, it should be understood that the heat-dissipation device (600) may include fewer or more annular fins, and the annular fins may possess configurations other than annular shapes. The first, second, and third annular fins (602), (604), and (606) dissipate heat from the conductor (620), and more specifically, fluid circulating around the surfaces of the annular fins (602), (604), and (606) function as a heat transfer medium for cooling the conductor (620) to an operable temperature. The fins (602), (604), and (606) may be a heat-conductive material, such as copper, copper alloy, aluminum, etc. Accordingly, the fin array shown herein prevents the conductor from overheating by absorbing its heat and dissipating the heat into the air and/or through a base (610), discussed below.

In FIGS. 6A and 6B, the annular fins (602), (604), and (606) are shown mounted on or positioned proximal to a base (610). The base (610) is depicted as a plate with a planar or relatively planar upper surface (610_{A}). It should be understood, however, that the base (610) may possess other shapes. For example, in an embodiment, the annular fins (602), (604), and (606) may be frictionally fitted between grommets (not shown), with the grommets incorporating the functionality of the base (610), which may be omitted. In an exemplary embodiment, the base (610) acts as a heat sink and is made of a heat-conductive material, such as copper, copper alloy, aluminum, etc. When mounted to the base, the annular fins (602), (604), and (606) are connected to the base (610) with solder (612), although adhesive, mechanical fasteners, or other connectors and thermal interface materials may be used.

The first, second, and third annular fins (602), (604), and (606), respectively, include corresponding openings, shown in FIG. 6A as first, second, and third central circular openings (602_{A}), (604_{A}), and (606_{A}), respectively. The annular fins (602), (604), and (606) are concentrically or relatively concentrically positioned around an exterior surface of the electrical conductor (620), so that each of the annular fins (602), (604), and (606) is centered on or coaxial to the longitudinal axis Aₓ of the electrical conductor (620). The first, second, and third annular fins (602), (604), and (606), respectively, are shown spaced apart from one another along the longitudinal axis A. The spacing is illustrated as uniform, although it should be understood that non-uniform or no spacing may be employed.

As shown in FIG. 6B, the diameter of the opening (602_{A}) of the first fin (602) is approximately equal to, or slightly greater than, the outer diameter of the electrical conductor (620). The diameters of openings of the second and third fins (604_{A}) and (606_{A}) may be similarly sized with respect to the outer diameter and exterior surface of the electrical conductor (620). Any gap between the outer surface of the electrical conductor (620) and the inner edges of the annual structures (602), (604), and (606) defining the openings (602_{A}), (604_{A}), and (606_{A}), respectively, is mitigated or eliminated following receipt of the conductor (620). In an exemplary embodiment, the fins (602), (604), and (606) are friction fitted on or with respect to the electrical conductor (620) so as to be not movable or to mitigate movement of the fins along the longitudinal axis A.

In an exemplary mode of operation, heat conveyed by the electrical conductor (620) is removed in part by the fins (602), (604), and (606) and transmitted to the base (610), which together function as a heat sink.

Load (130)

The thermal energy harvesting thermionic device (110) is electrically coupled to the load (130) by the electrical conductive path (132). In exemplary embodiments, the load (130) can be, for example, a power-consumption device and/or a rechargeable power storage device. Arrow (134) represents the flow direction of electrons leaving the anode (116).

For embodiments in which the electrical load (130) is embodied as a power-consumption device, the load (130) may be selected from a wide array of consumer and commercial products and goods, including, by way of example and not limitation, mobile telephones, cordless telephones, consumer electronics, portable electronics, computers such as laptop computers and tablet computers, personal digital assistants (PDAs), portable radios, power tools, watches, calculators, game systems and controllers, cameras, video recorders, portable televisions, global positioning systems (GPS), data transfer devices, home-consumer appliances, lighting goods and systems, home products, toys, headphones, DVD and CD players, MP3 players, voice recorders, sensors, controllers, grooming instruments, alarm systems, weapons such as stun guns, backup power sources, military equipment, emergency equipment, utility equipment, vehicle controls and systems, appliances, telecommunications, etc.

Appliances are conveniently cooled by natural convection and radiation or through the use of fluid movers, e.g. fans, especially internal fans. In an embodiment, natural convection cooling is desirable, since natural convection cooling does not involve fans that may break down or consume harvested energy. Natural convection is based on fluid motion caused by density differences driven by a temperature difference.

### Alternative Embodiments and Configurations (FIGS. 2 to 4)

FIG. 2 illustrates a modification to the embodiment of FIG. 1. FIG. 2 depicts a block diagram (200) of an apparatus (202) that includes an appliance (204) that generates heat, including but not limited to a heat by-product (206), a thermal energy harvesting thermionic device (210), a heat dissipation device (220), and a load (230) operatively connected to the apparatus (202) by an electrical conductive path (232) with electron flow (234). Arrow (234) represents the flow direction of electrons leaving the anode (216). Parts (202), (204), (206), (210), (212), (214), (216), (218), (220), (230), (232), and (234) have the same or similar properties and features of corresponding parts (102), (104), (106), (110), (112), (114), (116), (118), (120), (130), (132), and (134) respectively. In the interest of brevity, the description of components, features, properties, etc. associated with those parts of FIG. 1 is incorporated herein by reference with respect to FIG. 2.

A first difference between the block diagrams (100) and (200) of FIGS. 1 and 2, respectively, is an epoxy or adhesive (208) joining a surface (204_{A}) of the appliance (204) to a surface (210_{A}) of the thermal energy harvesting thermionic device (210). The appliance (204) is in close proximity to surface (214_{B}) of the cathode (214). In exemplary embodiments, the adhesive (208) is embodied as an adhesive composite designed to increase thermal conductivity between the appliance (204) and the thermal energy harvesting thermionic device (210). Thermal conductivity of adhesives such as epoxies and electronic adhesives can be increased by adding thermally conductive fillers and/or nanoparticles to the adhesive (208). Representative thermally conductive fillers include, for example, SiO₂, MgO, and Al₂O₃. Representative nanoparticles for increasing thermal conductivity include, for example, nitride (e.g., AIN, BN, Si₃N₄, etc.) nanoparticles. The thermally conductive fillers and/or nanoparticles added to epoxies, electronic adhesives, and other polymers function as high conductivity thermal interface materials (TIM) to increase the thermal conductivity of the adhesive composite and to transmit the thermal energy (heat) from the appliance (204) to the adjacently or proximally positioned thermionic device (210).

Examples of commercial TIM suppliers and materials include, without limitation, 3M (D270 Epoxy), Henkel AG and Co. (Loctite 315), Hitachi Chem. Corp. (XH9930-2), DOW Chemicals (TC-2035), and Kyocera Chem. Corp. (CT284R).

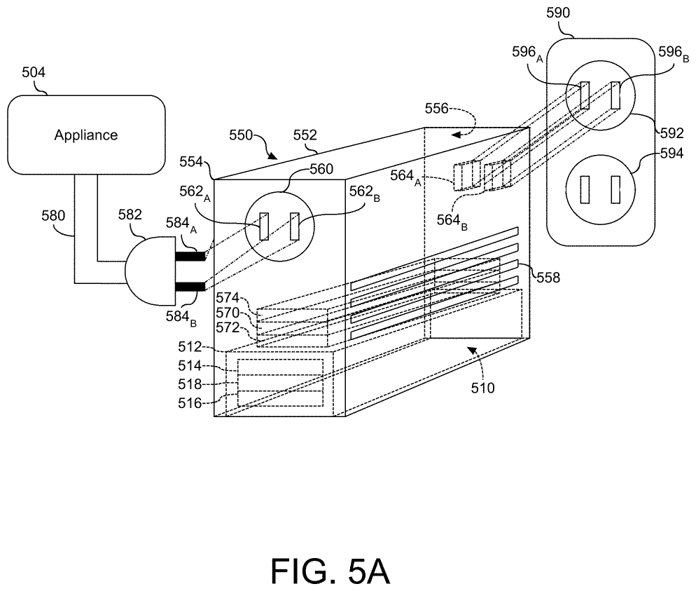

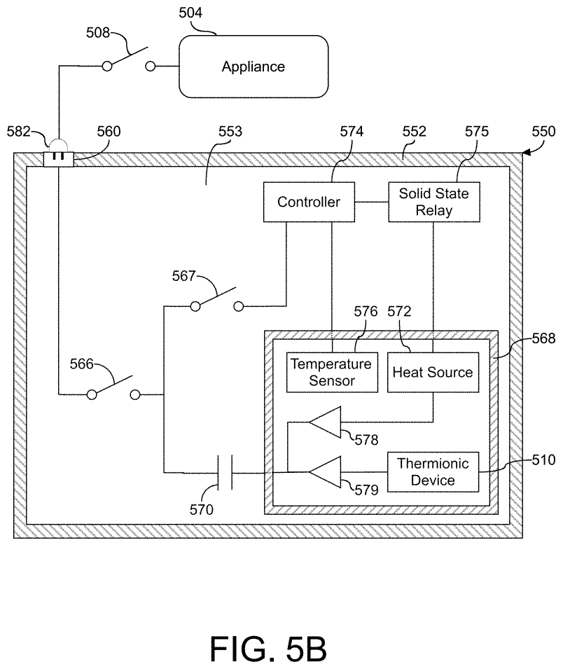

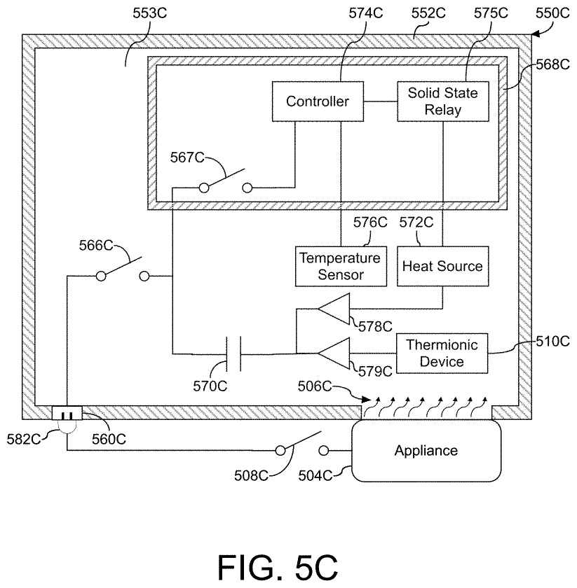

A second difference between the block diagrams (100) and (200) of FIGS. 1 and 2 is the addition of a temperature sensor and control unit (240) controlling a switch (242) positioned between the heat dissipation device (220) and the load (230). According to an exemplary embodiment, the temperature sensor and control unit (240) monitors the temperature of the thermal energy harvesting thermionic device (210) or a component thereof for a temperature drop below a temperature threshold. Examples of suitable operating steps, conditions, and other parameters applicable to the apparatus or system (202) are discussed below in connection with controller (574) of the embodiment of FIGS. 5A and 5B. It should be understood that the control unit (240) and the switch (242) may be positioned at other locations. The control unit (240) may control actuation of the switch (242) between an open position and a closed position. As shown by way of example, the open position prevents or mitigates electrical overload of the load (230), or alternatively in the closed position to enable completion of the path (232) from the thermionic device (210) to the load (230).

Referring to FIG. 3, another modification to the embodiment of FIG. 1 is illustrated. FIG. 3 depicts a block diagram (300) of an apparatus (302) that includes an appliance (304) depicted with a resistor (or other heat generating element) (342) that generates thermal energy or thermal energy byproduct (306), a thermal energy harvesting thermionic device (310) positioned proximal to or in communication with a first surface (304_{A}) of the appliance (304), a heat dissipation device (320), and an electrical conductive path (332). Arrow (334) represents the flow direction of electrons leaving the thermionic device (310). The parts (302), (304), (306), (310), (312), (314), (316), (318), (320), (332), and (334) have the same or similar properties and features of corresponding parts (102), (104), (106), (110), (112), (114), (116), (118), (120), (132), and (134), respectively. In the interest of brevity, the description of components, features, properties, etc. associated with those parts of FIGS. 1 and 2 is incorporated herein by reference with respect to FIG. 3.

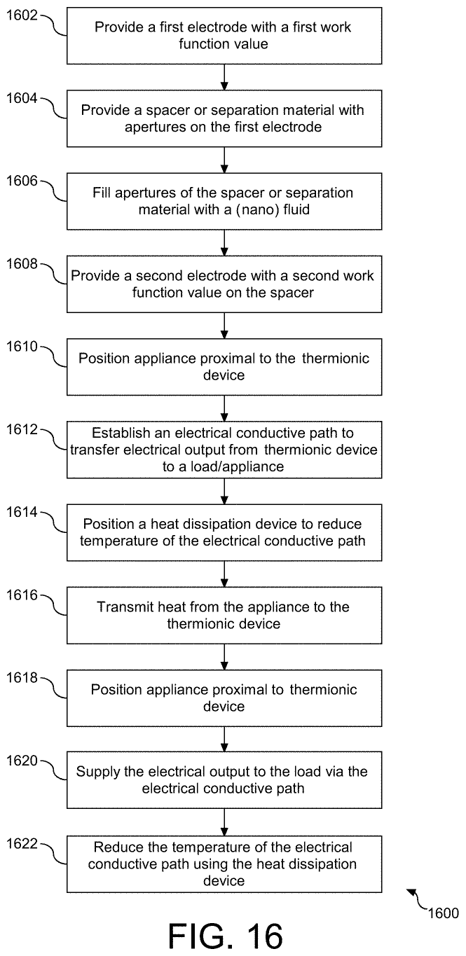

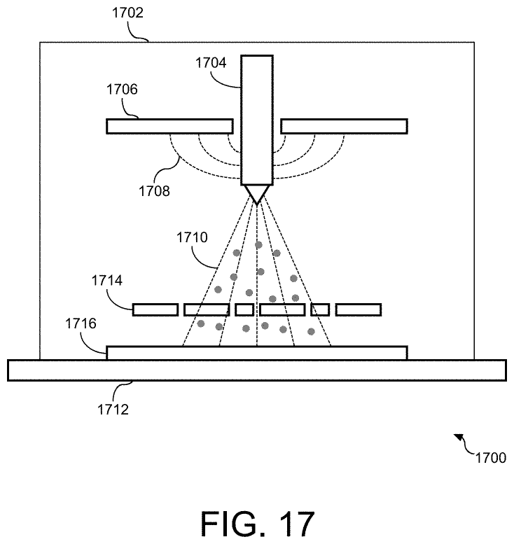

A first difference between the block diagrams (100) and (300) of FIGS. 1 and 3, respectively, is that the thermionic device (310) is formed or positioned directly on the appliance (304). A second surface (310_{A}) of the thermionic device (310) directly abuts the upper surface (304_{A}) of the appliance (304). In an exemplary embodiment, an electrospray deposition or printing technique, such as those described below, including in regard to FIGS. 16 and 17, may be employed to position the thermionic device (310) relative to the appliance (304). Alternatively or in addition thereto, one or more mechanical fasteners, e.g., (108_{A}) and (108_{B}) of FIG. 1 and/or adhesive, e.g., (208) of FIG. 2, may be used.

A second difference between the block diagrams (100) and (300) of FIGS. 1 and 3, respectively, is that the electrical conductive path (332) feeds electricity from the thermionic device (310) into the appliance (304). In this regard, the appliance (304) functions as a substitute for the loads (130) and (230) of FIGS. 1 and 2, respectively. In an exemplary embodiment, the thermionic device (310) and the appliance (304) operate synergistically to render the appliance (304) substantially autogenous or self-powered. Heat by-product from the resistor (or other heat generating element) (342) is communicated to the thermionic device (310) to convert heat or heat byproduct generated by the appliance (304) into electricity for continued operation of the appliance (304), which in turn generates heat for continued operation of the thermionic device (310). Eventually, the cycle will decrease to the point at which an outside electrical source, e.g., a battery or AC power source, should provide electricity to the appliance (304) and/or an outside heat source should provide thermal energy to the thermionic device (310).

A third difference between the block diagrams (100) and (300) of FIGS. 1 and 3, respectively, is the addition of an energy storage device (340) shown herein positioned external to a housing (308) of the appliance (304). In an alternative embodiment, the energy storage device (340) may be positioned internal to the appliance (304) or appliance housing (308). In an exemplary embodiment, one or more capacitors are selected as the electrical energy storage device (340), although other devices capable of storing electrical energy, e.g., a charge, may be used, especially for meeting large electrical demand periods. Unless otherwise indicated, the term capacitor can include supercapacitor, micro-capacitor, micro-supercapacitor, and the like. Examples of electrical energy storage devices that may be used instead of or in combination with one or more capacitors include, without limitation, inductors, fuel cells, non-rechargeable batteries, re-chargeable batteries, and other electrical energy storage elements.

Referring to FIG. 4, a modification to the embodiment of FIG. 3 is illustrated. FIG. 4 depicts a block diagram (400) of an apparatus (402) embodied as the appliance. The appliance (402) includes a housing (408) defining an internal chamber or compartment (450). The appliance (402) is in the form of an electrical appliance and includes a heat source (442), such as a resistor, and a capacitor (440). The heat source (442) generates thermal energy (406), either as a function of the appliance (402), e.g., a toaster or oven generating heat, or as a by-product.

A difference between the block diagrams (300) and (400) of FIGS. 3 and 4, respectively, is that the thermal energy harvesting thermionic device (410) is positioned within the chamber (450) of the housing (408) and positioned proximal to the heat source (442). Also within the chamber (450) of the housing (408) are a heat dissipation device (420) and an electrical conductive path (432). Arrow (434) represents the flow direction of electrons leaving the anode (416). The parts (402), (406), (410), (412), (414), (416), (418), (420), (432), (434), and (440) have the same or similar properties and features of corresponding parts (302), (306), (310), (312), (314), (316), (318), (320), (332), (334), and (340), respectively. In the interest of brevity, the description of components, features, properties, etc. associated with those parts of FIGS. 1-3 is incorporated herein by reference with respect to FIG. 4.

The apparatus (402) also includes a fluid-circulating device (422) operatively coupled to a thermal reservoir (424). The fluid-circulating device (422) may be, for example, one or more fans, impellers, blowers, or any device configured to facilitate fluid flow. Although the fluid-circulating device (422) is depicted enclosed within the appliance housing (408), it should be understood that the fluid-circulating device (422) may be externally situated with respect to the appliance housing (408). The fluid-circulating device (422) communicates with the thermal reservoir (424) via a pathway for thermal communication (426). The fluid-circulating device (422) may provide cooling fluid (e.g., gas, such as air) to the heat dissipation device (420), and thereby remove heat from the heat dissipation device (420), or exchange fluid (e.g., air) between the heat dissipation device (420) and the thermal reservoir (424). The pathway, also referred to herein as a passage, for thermal communication (426) may comprise, for example, one or more conduits, pipes, vents, ducts, other parts and passages, and/or combinations thereof. The thermal reservoirs (424) may comprise, for example, one or more cooling fluid reservoirs.

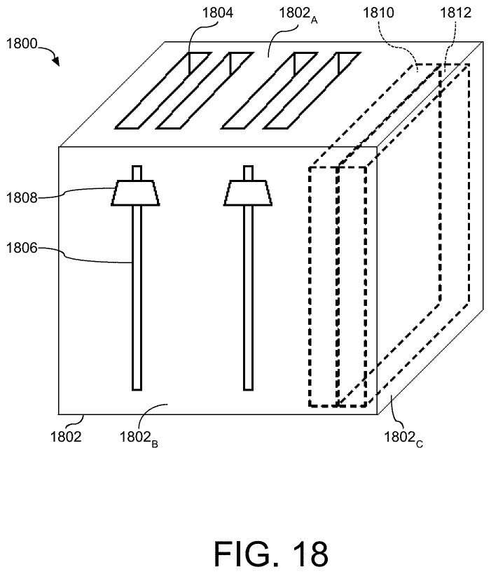

FIG. 18 is a non-limiting example of an apparatus or system (1800) embodied as a consumer appliance, in particular a toaster, incorporating a plurality of thermal energy harvesting thermionic devices. The apparatus (1800) is embodied as a toaster, and includes a housing (1802) having a first (top) surface (1802_{A}) and an opposite second (bottom) surface (not shown), a third (front) surface (1802_{B}) and an opposite fourth (rear) surface (not shown), and a first (right in FIG. 18) side surface (1802_{c}) and an opposite second (left in FIG. 18) side surface (not shown). The apparatus (1800) includes a plurality of receptacles (1804) that extend downward from the first surface (1802_{A}) into the housing (1802). Although not shown, heating elements are typically arranged on opposite sides of the receptacles (1804) for heating and toasting bread and other food product inserted into the receptacles (1804) of the toaster (1800). On the third surface (1802_{B}) of the housing (1802), a pair of vertically oriented slots (1806) each with a vertically slidable tab (1808) are provided. Either or both of the slidable tabs (1808) are configured to be pressed downward, typically by the finger of a user in a known manner, to slide along their respective vertical slots (1806), causing a carriage (not shown) internal to the housing (1802) to move downwardly. Bread or other food product received in the carriage is correspondingly lowered into the body of the housing (1802), between heating elements (not shown), which typically are activated by depression of one or both of the slidable tabs (1808). Controllers (not shown), such as control knobs, may be provided to control the temperature of the heating elements (not shown) and/or the heating time, e.g., to make toast.

As shown, the apparatus (1800) includes a plurality of thermal energy harvesting thermionic devices, shown herein as a first thermal energy harvesting thermionic device (1810) and a second thermal energy harvesting thermionic device (1812), positioned within the housing (1802). The first and second thermionic devices (1810) and (1812), respectively, are shown arranged in side-by-side (adjacent) relationship to one another. Alternative arrangements may be practiced, including stacked and other arrangements. For example, the first thermionic device (1810) can be positioned on the first (right) side (1802_{c}) of the housing (1802) and the second thermionic device (1812) can be positioned adjacent to the opposite second (left) side (not shown) of the housing (1802). Alternatively, the thermionic devices can be positioned adjacent to the first surface (1802_{A}) and/or the opposite second surface (not shown in FIG. 18). While two thermionic devices (1810) and (1812) are shown in FIG. 18, it should be understood that the toaster (1800) may include one, two, or more than two thermionic devices. The first and second thermionic devices (1810) and (1812), respectively, may be electrically connected with one another, either in parallel or in series.

While FIG. 18 shows the thermionic devices (1810) and (1812) incorporated into the housing (1802) of the apparatus (toaster) (1800), it should be understood that the thermionic device or devices may be positioned external to the appliance. According to an exemplary embodiment, the shape of a least one surface of the thermionic device or devices conforms to the shape of the exterior surface of the housing of the appliance. For example, if a surface of the appliance is concave, the conforming surface of the thermionic device may be convex with a matching or substantially matching curvature.

In exemplary embodiments, the thermionic device or devices, e.g., (1810) and (1812) provide structural support for and add structural integrity to the appliances, e.g., the apparatus (1800), while adding minimal mass and size to the appliance(s).

Another exemplary embodiment will now be discussed in connection with FIGS. 5A and 5B, which illustrate a system (502) including an appliance (504), an electrical power source (590), and a portable apparatus or charger (550). The appliance (504) is shown in FIG. 5A with an insulated conductor such as an electrical cord (580), which is configured to transmit electricity either directly or indirectly from a power source or power outlet (590) to the appliance (504). A distal end of the insulated conductor (580) is provided with a male electrical coupling member embodied as an electrical plug (582), which is shown in FIG. 5A with a pair of male electrical contact prongs (584_{A}) and (584_{B}). In an exemplary embodiment the insulated conductor (580) via the electrical plug (582) is configured for electrically coupling the appliance (504) with a female electrical coupling member of an electrical power source (590), embodied in FIG. 5A as a United States (U.S.) standard size alternating current (AC) socket, such as either of sockets (592) or (594) of a twin-socket wall outlet, also designated herein by reference numeral (590). The various electrical coupling connections can be modified to comply with standard size and operating parameters of other countries.

As shown herein, the portable apparatus (or charger) (550) is provided to receive the plug (582). The apparatus (550) includes a portable housing (552) defining a body with a chamber or compartment (553) (FIG. 5B). As best shown in FIG. 5A, the housing (552) includes a first (front) face (554) and an oppositely positioned second (rear) face (556). The front face (554) includes a female electrical coupling member embodied as a single electrical socket (560) with a pair of recesses or receptacles (562_{A}) and (562_{B}) with internal electrical terminals, and constructed or configured to receive and electrically couple with a standard AC plug, such as the male plug (582), so that the contact prongs (584_{A}) and (584_{B}) are received in the receptacles (562_{B}) and (562_{A}), respectively, to electrically connect the portable charger (550) to the appliance (504). A projecting line in FIG. 5A represents insertion of the male electrical contact prongs (584_{B}) into the receptacle (562_{B}).

The rear face (556) of the apparatus (550) includes a male electrical coupling member embodied as male electrical contact prongs (564_{A}) and (564_{B}) extending from the housing (552). The male electrical contact prongs (564_{A}) and (564_{B}) are configured for electrically coupling with a socket of a standard AC outlet, such as either of the sockets (592) or (594) of the wall outlet (590) for charging the apparatus (550). Projecting lines in FIG. 5A represent insertion of the male electrical contact prongs (564_{A}) and (564_{B}) into receptacles (596_{A}) and (596_{B}), respectively, of socket (592).

The apparatus (550) includes additional components for creating and/or supplying a power reserve for operation of the appliance (504), such as in the event that electricity is not available from an electrical outlet, e.g., outlet (590). A thermal energy harvesting thermionic device (510) is positioned within the body encompassed or defined by the housing (552). In an exemplary embodiment, a plurality of interconnected thermal energy harvesting thermionic devices (see FIG. 15) may be provided in place of a single such thermionic device (510). The thermionic device (510) (or devices) includes a housing (512), a cathode/emitter electrode (514), an anode/collector electrode (516), and an inter-electrode gap (518) containing a nano-fluid. The thermionic device (510), including the housing (512), the cathode (514), the anode (516), and the inter-electrode gap (518) are shown in broken lines or dashes in FIG. 5A, because in an exemplary embodiment each would be hidden or non-visible once placed with the body encompassed or defined by the housing (552) (unless the housing (552) was made of a transparent material). The parts (504), (510), (512), (514), (516), and (518) have the same or similar properties and features of corresponding parts (104), (110), (112), (114), (116), and (118), respectively. In the interest of brevity, the description of components, properties, features, etc. associated with those parts of FIGS. 1-4 is incorporated herein by reference with respect to FIGS. 5A and 5B.

Also positioned within the housing (552) are an electrical energy storage device (570), a heat source (572), and a controller (574). The electrical energy storage device (570), the heat source (572), and the controller (574) are shown in broken lines or dashes in FIG. 5A, because in an exemplary embodiment each would be hidden or non-visible within the housing (552). The heat source (572), the electrical energy storage device (570), and the controller (574) are shown stacked on one another and adjacently positioned with respect to the housing (512) of the thermionic device (510), with the electrical energy storage device (570) interposed between the heat source (572) and the controller (574). It should be understood that different arrangements of the components (570), (572), and (574) with respect to one another and/or with respect to the thermionic device (510) may be implemented.

As shown in FIG. 5B (but omitted from FIG. 5A for clarity purposes), the apparatus (550) further includes an internal housing (568). The internal housing (568) encloses the heat source (572), a temperature sensor (576), and the thermal energy harvesting thermionic device (510). In an exemplary embodiment, the internal housing (568) is a thermal barrier that allows heat generated by the heat source (572) to be exposed to the temperature sensor (576) and the thermionic device (510), but that shields, insulates, or otherwise protects other components of the apparatus (550) (such as the electrical energy storage device (570), the controller (574), and solid state relay (575)) from the heat generated by the heat source (572). In an exemplary embodiment, the internal housing (568) is made of a thermally non-conductive material. In another exemplary embodiment, the internal housing (568) is comprised of an aerogel material. Notably, other embodiments disclosed herein, including those of FIGS. 1-4, may include an internal housing comprised of an aerogel or other material, e.g., for providing heat shielding.

In an exemplary embodiment, one or more capacitors are selected as the electrical energy storage device (570), although other devices capable of storing electrical energy, e.g., a charge, may be used. Unless otherwise indicated, the term capacitor can include supercapacitor, micro-capacitor, micro-supercapacitor, and the like. Examples of electrical energy storage devices that may be used instead of or in combination with one or more capacitors include, without limitation, inductors, fuel cells, non-rechargeable batteries, re-chargeable batteries, and other electrical energy storage elements.

In an exemplary embodiment, the controller (574) detects an electrical coupling between the apparatus (550) and a power source (590), and more particularly insertion of the male electrical contact prongs (564_{A}) and (564_{B}) into the receptacles (596_{A}) and (596_{B}), respectively, of the electrical socket (592). Electrical energy is stored in the electrical energy storage device (570) by electrically coupling the apparatus (550) with the power source (590). In particular, the male electrical contact prongs (564_{A}) and (564_{B}) are inserted into the respective receptacles (596_{A}) and (596_{B}) of the socket (592), as shown by the dashed projecting lines in FIG. 5A. The controller (574) closes switch (566) to electrically connect the electrical energy storage device (570) to the electrical socket (592) and allow for charging of the electrical energy storage device (570). After the electrical energy storage device (570) has been charged, the portable apparatus (550) may be electrically uncoupled from the electrical power source (590), or the controller (574) opens the switch (566).

In use, the portable apparatus (550) is electrically coupled to the appliance (504). Turning the appliance (504) on closes switch (508) of the appliance (504). In an exemplary embodiment, the controller (574) detects the position of the switch (508) and the electrical coupling between the appliance (504) and the apparatus (550), and more particularly insertion of the male electrical contact prongs (584_{A}) and (584_{B}) of the plug (582) into the receptacles (562_{B}) and (562_{A}), respectively, of the electrical socket (560). The electrically coupling between the appliance (504) and the apparatus (550) causes the controller (574) to close the switch (566). Electricity generated by the thermionic device (510) is supplied to the appliance (504) across the closed switches (508) and (566).

In an embodiment, the controller (574) includes one or more temperature sensors such as the temperature sensor (576), which may be embodied as one or more thermocouples. Although the controller (574) and the temperature sensor (576) are depicted in FIG. 5B as distinct components from one another, it should be understood that the controller (574) and the temperature sensor(s) (576) may be combined with or otherwise incorporated into one another as a single component.

The controller (574) is operatively connected to the temperature sensor (576) to monitor the temperature of the thermionic device (510) or one or more of the components of the thermionic device (510). In an exemplary embodiment, the temperature of the cathode or a conductor contacting the cathode is monitored by the controller (574) and the temperature sensor (576). In another embodiment, the temperature of the anode or a conductor operatively coupled to the anode is monitored. In still another embodiment, the temperature of the nano-fluid is monitored by the controller (574) and the temperature sensor (576).

The controller (574) and the temperature sensor (576) monitor the temperature of the thermal energy harvesting thermionic device (510) or a component thereof for a temperature drop below a temperature threshold. In an embodiment, the temperature threshold is a temperature value. In another embodiment, the temperature threshold is a range of temperatures. The temperature threshold may be predetermined. For example, the temperature threshold may be any value between the freezing point and the boiling point of the nano-fluid (discussed below) of the thermal energy harvesting thermionic device (510). In another embodiment, the temperature threshold is a temperature difference (temperature gradient) between the cathode and anode.

In response to detection that the temperature (as monitored by the temperature sensor (576)) of the thermal energy harvesting thermionic device (510) has fallen below the temperature threshold, the controller (574) closes switch (567). Electricity is supplied from the electrical energy storage device (570) through the solid state relay (575) to the heat source (572). As current (typically direct current (DC)) flows from the electrical energy storage device (570) to the heat source (572), the electrical energy is converted by the heat source (572) into heat (or thermal energy).

In an exemplary embodiment, heat is the by-product of resistance of a circuit component, including but not limited to resistors. In an exemplary embodiment, the heat source (572) comprises one or more resistors. Various types of resistors may be employed. In an exemplary embodiment, selection or employment of resistors is configurable. For example, resistors suitable for use as the heat source (572) may have a resistance in a range of, for example, about 0.01 ohms to about 10 k ohms (10,000 ohms) and/or a power dissipation rating of, for example, about 0.001 watts to about 1 or more megawatts. Other heating sources with low thermal resistance change may be used instead of or in addition to a resistor.

The heat source (572) is positioned proximal to the thermal energy harvesting thermionic device (510) so that the thermal energy generated by the heat source (572) thermally perturbs the thermal energy harvesting thermionic device (510). In an exemplary embodiment, the controller (574), through switch activation, activates the heat source (572) to generate a temperature in a range of about −200° C. to about 2,000° C. In an exemplary embodiment, the temperature range is correlated with the composition of the nano-fluid. For example, at −200° C. the nano-fluid composition may include an alkali metal, and at the highest temperature range the nano-fluid composition may include molten salts. Similarly, in another embodiment, at room temperature, such as 25° C. to 200° C., the nano-fluid composition may include organics, such as toluene, alkanes, alkane thiols, and/or water, with each composition having respective operational temperatures or temperature ranges.

In an exemplary embodiment, the controller (574) closes the switch (567) for a period of about 4-10 seconds to about 100 seconds, which is sufficient time for the electrical energy storage device (570) to supply electricity to the heat source (572) to generate heat for harvesting by the thermal energy harvesting thermionic device (510). The amount of time selected for activating the electrical energy storage device (570) may be based on various factors, including but not limited to the ambient temperature of the environment in which the device (510) is located, the temperature of the nano-fluid prior to activation, etc. The magnitude of the resulting current produced by the thermal energy harvesting thermionic device (510) will depend upon many factors, including the heat energy emitted by the heat source (572). In an exemplary embodiment, activating the heat source (572) for a limited duration, e.g. seconds, can increase the electrical output of the thermal energy harvesting thermionic device (510) for an extended duration, e.g. hours.

The electricity channeled through the heat source (572) and generated by the thermionic device (510) charges the electrical energy storage device (570) and supplies electricity to the appliance (504). As best shown in FIG. 5B, diodes (578) and (579) are provided within the internal housing (568) for controlling the flow of electricity.

When the appliance (504) is turned off or unplugged from the electrical socket (560) of the apparatus (550), the controller (574) opens the switch (566) and, if closed, the switch (567) as well.

The controller (574), which may be embodied as a control circuit, may include at least one processor (e.g., a microprocessor), at least one microcontroller, at least one programmable logic device (e.g., field programmable gate arrays, programmable array logic, programmable logic devices), at least one application specific integrated circuit, or the like, or combinations including one or more thereof. The controller (574) may include or operatively communicate with a memory or memory module. Memory or memory modules may be in the form of nonvolatile data stores, such as hard drives and/or nonvolatile memory. A non-exhaustive list of more specific examples of memory includes the following: a portable computer diskette, a hard disk, a dynamic or static random access memory (RAM), a read-only memory (ROM), an erasable programmable read-only memory (EPROM or Flash memory), a magnetic storage device, a portable compact disc read-only memory (CD-ROM), a digital versatile disk (DVD), a memory stick, and any suitable combination of the foregoing. The memory may store one or more software-based control applications that include instructions that the control circuit executes to perform the functions described herein.

The housing (552) is depicted in FIG. 5A with a plurality of openings or fenestrations (558), illustrated as parallel or substantially parallel slots in FIG. 5A, in a side surface (unnumbered) of the housing (552). The size, shape, and position of the openings or fenestrations (558), hereinafter referred to as openings, may vary and should not be considered limiting. The openings (558) allow for passive heat exchange between the thermal energy harvesting thermionic device (510) located internal to the housing (552) and the ambient environment located outside of the housing (552). The openings (558) may be configured to have alternative quantities, shapes, spacing, and proportions to those shown in FIG. 5A. Further, the openings (558) may be formed on any or all of the surfaces of the housing (552), including but not limited to the front face (554) and the rear face (556).

FIG. 5C depicts an alternative circuit diagram similar to but different from the circuit diagram of FIG. 5B. FIG. 5C includes like reference numerals to FIGS. 5A and 5B, but with the addition of the suffix “C” to the parts of FIG. 5C. Parts (504C), (508C), (510C), (550C), (552C), (553C), (560C), (566C), (567C), (568C), (570C), (572C), (574C), (575C), (576C), (578C), (579C), and (582C) have the same or similar properties and features of corresponding parts (504), (508), (510), (550), (552), (553), (560), (566), (567), (568), (570), (572), (574), (575), (576), (578), (579), and (582), respectively. In the interest of brevity, the description of components, properties, features, etc. associated with those parts of FIGS. 5A and 5B is incorporated herein by reference with respect to FIG. 5C.

In the apparatus (550C) of FIG. 5C, the internal housing (568C), which in an exemplary embodiment functions as a heat shield, encloses or houses the controller (574C) and the solid state relay (575C). The thermionic device (510C), the heat source (572C), and the temperature sensor (576C) are positioned outside of the internal housing/heat shield (568C). Although the electrical energy storage device (570C) is shown positioned outside of the internal housing/heat shield (568C), it should be understood that the electrical energy storage device (570C) and other components shown positioned outside the internal housing/heat shield (568C) in FIG. 5C) may be housed or otherwise positioned within the internal housing/heat shield (568C).

Positioning the thermionic device (510C) and the heat source (572C) outside of the internal housing/heat shield (568C) exposes the thermionic device (510C) and the heat source (572C) to thermal energy or heat (506C) generated by the appliance (504C). A break or opening proximal to the appliance (504C) and the thermionic device (510C) may be provided in the housing (552C) for increasing the exposure of the thermionic device (510C) to the heat (506C) generated by the appliance (504C). This thereby reduces the burden on the electrical energy storage device (570C) to provide electricity for activating the heat source (572C).

An additional feature that may be practiced with the apparatus (550C) of FIG. 5C is that the controller (574C) may be programmed to activate one or more of the switches, e.g., switches (508C), (566C), and/or (567C), if it is determined that the temperature of the thermionic device (510C), as measured by the temperature sensor (576C), exceeds a predetermined value. Although this feature is not discussed above in connection with FIG. 5B because the thermionic device (510) is protected by the internal housing/heat shield (568) and thus less susceptible to overheating, it should be understood that the controller (574) of FIG. 5B may be programmed with the same functionality.

Although some embodiments disclosed herein involve use of the apparatus or system (102) with a rechargeable electrochemical battery for recharging the battery, in exemplary embodiments the electrochemical battery is omitted to eliminate the various problems associated with electrochemical battery use, including electrochemical degradation and recharge cycles. Further, exemplary embodiments of the thermionic devices can operate at power densities (e.g. 1500 watts/kg) exceeding those of lithium ion batteries, avoid the need for potentially harmful and/or hazardous electrochemical materials, have long service and shelf lives, can operate under mechanical stress conditions, and/or reduce life-cycle costs.

Re-Chargeable Power Storage Embodiments

In an embodiment, a re-chargeable power storage device can be electrically coupled to the power-consumption device to discharge electrical energy into the power-consumption device, and to be re-charged in multiple cycles. In an exemplary embodiment, the re-chargeable power storage device comprises one or more re-chargeable batteries. Non-limiting examples of re-chargeable batteries include lithium ion, lithium-ion polymer, lead-acid, nickel-cadmium, and nickel-metal hydride batteries. In another embodiment, the re-chargeable power storage device comprises one or more secondary cells. In the embodiment of FIG. 1, direct current (DC) output of the thermal energy harvesting thermionic device (110) is supplied to the load (130) with a re-chargeable power storage device, such as the apparatus (550), for re-charging. In other embodiments described herein, the DC output may be supplied directly to an electrical load, such as a power-consumption device (in addition or in the alternative to the re-chargeable power storage device).

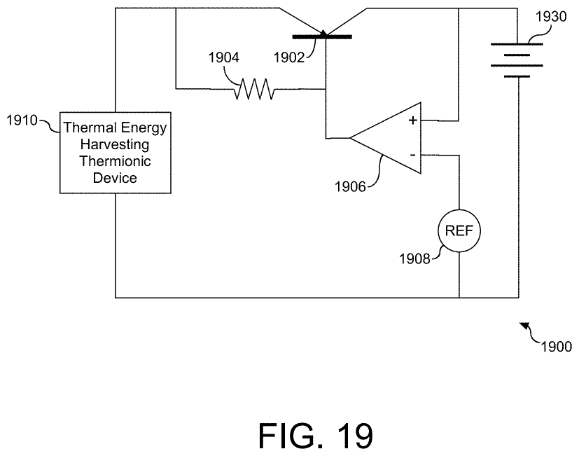

FIG. 19 is a diagram of a charging circuit (1900) according to an exemplary embodiment that may be used as the charging circuit of the embodiment of FIG. 1 for controlling the charging of a re-chargeable power storage device of the load (130). The charging circuit (1900) controls the flow of charging electrical energy from the thermal energy harvesting thermionic device (1910) to the re-chargeable power storage device, for example, to provide for electrical energy flow only when the power storage device is in need of re-charging.

The charging circuit (1900) of FIG. 19 includes a series pass element (1902), a resistor (1904), a comparator (1906), and a reference voltage (1908). The charging circuit (1900) is shown operatively connected to a thermionic device (1910), which in an embodiment is the thermionic device (110), (210), (310), (410), (510) of FIG. 1, 2, 3, 4, or 5, respectively. The charging circuit (1900) is operatively coupled to the thermal energy harvesting thermionic device (1910) and a load (1930), e.g., the re-chargeable power storage device.

The thermal energy harvesting thermionic device (1910) functions as a power source in the charging circuit (1900) shown in FIG. 19. When the thermal energy harvesting thermionic device (1910) is connected to the charging circuit (1900), the output of the comparator (1906) is low if the voltage of the load (1930), e.g., re-chargeable power storage device, is below the reference voltage (1908). The reference voltage is typically set at a termination voltage of the re-chargeable power storage device (1930). As known in the art, a battery charged beyond its termination voltage, also known as an over-voltage condition, can compromise reliability of a battery cell(s). For example, in the case of a single-cell lithium battery, the termination voltage may range from 4.1 to 4.2 volts, although these values should not be considered limiting. Low output from the power storage device (1930) enables the comparator (1906) to switch on the series pass element (1902). In the illustrated embodiment, the series pass element (1902) is illustrated as a bipolar junction transistor, which is provided by way of example. It should be understood that other mechanisms may be used as the series pass element (1902). Once the series pass element (1902) is switched on, current flows from the thermal energy harvesting thermionic device (1910) to the load (1930) (e.g., re-chargeable power storage device). When the re-chargeable power storage device (1930) has been charged to a voltage that meets or exceeds the reference voltage (1908), the comparator (1906) switches off the series pass element (1902). The resistor (1904) ensures that the series pass element (1902) switches off. In a non-limiting embodiment, the resistor (1904) is a pull-up resistor.

The charging circuit (1900) of FIG. 19 is an example of a charging circuit that may be used with embodiments described herein. Charging circuits are well known, and hence other charging circuits may be incorporated into the various embodiments described herein. It is within the scope of this disclosure to incorporate charging circuits having special charging capabilities, such as pulse charging or trickle charging. Examples of trickle charging circuits are disclosed in U.S. Pat. No. 6,492,792.

Thermal Energy Harvesting Thermionic Devices (110), (210), (310), (410), (510)

Embodiments of the thermal energy harvesting thermionic devices (110), (210), (310), (410), and (510) are described in greater detail with reference to FIGS. 7-15. Referring to FIG. 7, a diagram is provided to illustrate a sectional view of an embodiment of a thermal energy harvesting thermionic device (700) that is configured to convert thermal energy (or heat) into electrical power, i.e., electricity. In exemplary embodiments, the device (700) may be nano-scale and/or contain one or more nano-scale components. Each of the dimensions, including a thickness dimension defined parallel to a first-axis, also referred to herein as a vertical axis, i.e., Y-axis in FIG. 7, a longitudinal dimension parallel to a second-axis, i.e., X-axis in FIG. 7, also referred to herein as a horizontal axis, and a lateral dimension parallel to a third axis-axis, i.e. Z-axis in FIG. 7, orthogonal to the X-axis and Y-axis, are shown for reference. The X-axis, Y-axis, and Z-axis are orthogonal to each other in physical space.

The thermal energy harvesting thermionic device (700) is sometimes referred to herein as a cell. In exemplary embodiments, the thermal energy harvesting thermionic device (700) is illustrated as a sheet or a plurality of adjacently positioned sheets or layers, e.g., that may be stacked or wound. A plurality of devices (700) may be organized as a plurality of cells, or a plurality of layers, with the cells or layers arranged in series or parallel, or a combination of both to generate electrical output at the desired voltage, current, and power.

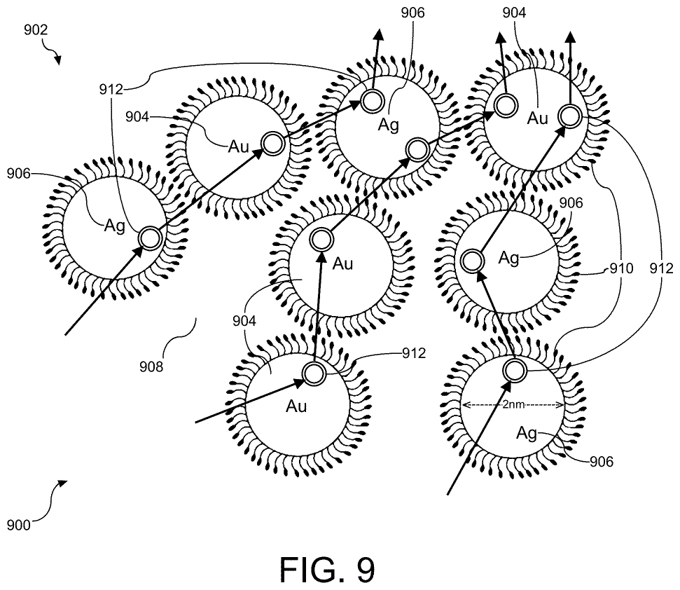

The thermal energy harvesting thermionic device (700) includes an emitter electrode (also referred to herein as the cathode) (702) and a collector electrode (also referred to herein as the anode) (704) positioned to define an inter-electrode gap (or interstitial space) therebetween. In an embodiment, a spacer (706) of separation material, sometimes referred to herein as a standoff or spacer, maintains separation between the electrodes (702) and (704). While the spacer (706) is referred to herein in the singular, it should be understood that the spacer (706) may comprise a plurality of elements. The spacer (706) may be a dielectric or insulator, or comprise one or more materials that collectively exhibit electrically non-conductive properties. The spacer (706) is illustrated in direct contact with the electrodes (702) and (704). The electrodes (702) and (704) and the spacer (706) define a plurality of closed apertures (708), also referred to herein as cavities, in the inter-electrode gap. The apertures (708) extend in the Y direction between the electrodes (702) and (704) for a distance (710) in a range, for example, of about 1 nanometer (nm) to about 100 nm, or in a range, for example, of about 1 nm to about 20 nm. A fluid (712), also referred to as a nano-fluid (discussed further herein with reference to FIG. 9), is received and maintained within one or more, and preferably each, of the apertures (708).

In alternative embodiments, no spacer (706) is used and only the nano-fluid (712) is positioned between the electrodes (702) and (704). Accordingly, the thermal energy harvesting thermionic device (700) includes two opposing electrodes (702) and (704), optionally separated by the spacer (706) with a plurality of apertures (708) extending between the electrodes (702) and (704) and configured to receive the nano-fluid (712).

The emitter electrode (702) and the collector electrode (704) each may be fabricated from different materials, with the different materials having separate and different work function values. The work function of a material or a combination of materials is the minimum thermodynamic work, i.e., minimum energy, needed to remove an electron from a solid to a point in a vacuum immediately outside a solid surface of the material. The work function is a material-dependent characteristic. Work function values are typically expressed in units of electron volts (eV). Accordingly, the work function of a material determines the minimum energy required for electrons to escape the surface, with lower work functions generally facilitating electron emission.

The difference in work function values between the electrodes (702) and (704) due to the different electrode materials influences the voltage that can be achieved. Thus, to generate high power, the difference in work function values between the electrodes (702) and (704) is large in an exemplary embodiment. In an embodiment, the work function value of the collector electrode (704) is smaller than the work function value of the emitter electrode (702). The different work function values induces a contact potential difference between the electrodes (702) and (704) that has to be overcome, e.g., by the application of heat to the emitter electrode (702), to transmit electrons through the nano-fluid (712) within the apertures (708) from the emitter electrode (702) to the collector electrode (704). The total of the work function value of the collector electrode (704) and the contact potential difference is less than or equal to the work function of the emitter electrode (702) in an exemplary embodiment. Maximum flow occurs when the total of the work function value of the collector electrode (704) and the contact potential equals the work function of the emitter electrode (702).

Both electrodes (702) and (704) emit electrons; however, once the contact potential difference is overcome, the emitter electrode (702) will emit significantly more electrons than the collector electrode (704), which is influenced by an electric field that suppresses electron production from the collector electrode (704). A net flow of electrons is transferred from the emitter electrode (702) to the collector electrode (704), and a net electron current (714) flows from the emitter electrode (702) to the collector electrode (704) through the apertures (708). This net electron current (714) causes the emitter electrode (702) to become positively charged and the collector electrode (704) to become negatively charged. Accordingly, the thermal energy harvesting thermionic device (700) generates an electron flow (714) that is transmitted from the emitter electrode (702) to the collector electrode (704).

The emitter electrode (702) may be manufactured with a first backing (716), which may comprise, for example, a polyester film, e.g., Mylar®, and a first layer (718) extending beneath the first backing (716). The first layer (718) may be comprised, for example, graphene, platinum (Pt), or other suitable materials. In an embodiment, the emitter electrode (702) has an emitter electrode thickness measurement (720) extending in the Y direction that is, for example, approximately 0.25 millimeters (mm), such measurement being non-limiting, or in a range of, for example, about 2 nm to about 0.25 mm, such measurements being non-limiting. The first backing (716) is shown in FIG. 7 with a first backing thickness measurement (722), and the first layer (718) is shown herein with a first layer thickness measurement (724), each extending in the Y direction. In an embodiment, the first backing thickness measurement (722) and the first layer thickness measurement (724) are in a range of, for example, about 0.01 mm to about 0.125 mm, or, for example, 0.125 mm, such values being non-limiting. The first backing measurement (722) and the first layer measurement (724) may have the same or different measurement values.

In an exemplary embodiment, prior to assembly, the first layer (718) is sprayed onto the first backing (716) so as to embody the first layer (718) as a nanoparticle layer that is approximately 2 nm (i.e., the approximate diameter of a nanoparticle), where the 2 nm value should be considered non-limiting. In an embodiment, the thickness (724) of the first layer (718) may be in a range of, for example, about 1 nm to about 20 nm, or about 2 nm to about 20 nm. In another embodiment, the thickness (724) of the first layer (718) may be in a range of, for example, 0.01 mm to 0.125 mm. Generally, smaller thicknesses have higher energy densities and less wasted energy. The first backing (716) has a first outer surface (728). The first backing (716) and the first layer (or the nanoparticle layer) (718) define a first interface (730) therebetween. The first layer (or the nanoparticle layer) (718) defines a first surface (732) facing the inter-electrode gap. Alternatively to spraying, the first layer (718) may be pre-formed and applied to the first backing layer (716), or vice versa, i.e., the first backing layer (716) applied to the first layer (718).

A first coating (734), such as cesium oxide (Cs₂O), at least partially covers the first surface (732) to form an emitter surface (736) of the first electrode (702) that directly interfaces with a first spacer surface (738). Accordingly, the emitter electrode (702) of the embodiment illustrated in FIG. 7 includes a first layer (or nanoparticle layer) (718) interposed between the first backing (716) and the first coating (734).

In FIG. 7, the collector electrode (704) includes a second backing (746), which may comprise, for example, a polyester film, and at least one second layer (748), which may comprise, for example, graphene or aluminum (Al), extending over the second backing (746). The collector electrode (704) has a collector electrode thickness measurement (750) extending in the Y direction that is, for example, approximately 0.25 millimeters (mm), such measurement being non-limiting, or in a range of, for example, about 2 nm to about 0.25 mm, such values being non-limiting. For example, in an embodiment, a second backing measurement (752) of the second backing (746) and a second layer measurement (754) of the second layer (748) are each approximately 0.125 mm, such values being non-limiting. In an embodiment, the second backing measurement (752) and the second layer measurement (754) may range from, for example, about 0.01 mm to about 0.125 mm, or each approximately 0.125 mm, such values being non-limiting. The second backing measurement (752) and the second layer measurement (754) may have the same or different measurement values.

In an embodiment, the second layer (748) is sprayed on to the second backing (746) to embody the second layer (748) as a second nanoparticle layer that is approximately 2 nm thick, where the 2 nm value should be considered non-limiting. The second layer measurement (754) of the second layer (748) may range from, for example, about 1 nm to about 20 nm, or about 2 nm to about 20 nm. In another embodiment, the second layer measurement (754) of the second layer (748) may be in a range of, for example, 0.01 mm to 0.125 mm. As discussed above in connection with the first layer (718), generally, smaller thicknesses have higher energy densities and less wasted energy. The second backing (746) has a second outer surface (758). The second backing (746) and the second layer/nanoparticle layer (748) define a second interface (760). The second layer (or the second nanoparticle layer) (748) defines a second surface (762) facing the inter-electrode gap. Alternatively to spraying, the second layer (748) may be pre-formed and applied to the second backing (746) or vice versa, i.e., the second backing (746) applied to the second layer (748).

A second coating (764), which may be comprised of cesium oxide (Cs₂O), at least partially covers the second surface (762) to form a collector surface (766) of the collector electrode (704) that directly interfaces with a second surface (768) of the spacer (706). Accordingly, the collector electrode (704) of FIG. 7 includes the second layer/nanoparticle layer (748) on the second backing (746) and the Cs₂O coating (764) on the second surface (762).

In an exemplary embodiment, the first coating (734) and the second coating (764) are formed on the first and second surfaces (732) and (762), respectively. In an embodiment, an electrospray or a nano-fabrication technique is employed to form or apply the first and second coatings (734) and (764), respectively. The first and second coatings (734) and (764) can be applied in one or more predetermined patterns that may be the same as or different from one another.

In exemplary embodiments, a percentage of surface area coverage of each of the first surface (732) and second surface (762) with the respective coating layers (734) and (764) (e.g., Cs₂O) is within a range of at least 50%, and up to 70%, and in at least one embodiment is about 60%. The Cs₂O coatings (734) and (764) reduce the work function values of the electrodes (702) and (704) from the work function values of, for example, platinum (Pt), which is an embodiment is 5.65 electron volts (eV), and aluminum (Al), which in an embodiment is 4.28 eV. The emitter electrode (702) with the coating layer (734) of Cs₂O has a work function value ranging from about 0.5 to about 2.0 eV, and in an embodiment is approximately 1.5 eV, and the collector electrode (704) with the coating layer (764) of Cs₂O has a work function value of about 0.5 to about 2.0 eV, and in an embodiment is approximately 1.5 eV.

In an embodiment, the electrodes (702) and (704) are comprised of graphene, and are referred to herein as graphene electrodes (702) and (704). The graphene electrodes (702) and (704) can exhibit work function values below 1.0 eV when coated with cesium oxide, gold, tungsten, and other elements and compounds. Sulfur may be incorporated into the coatings (734) and (764) to improve the bonding of the coatings (734) and (764) to the graphene electrodes (702) and (704), respectively, particularly where the first and second layers (718) and (748) of the electrodes (702) and (704) comprise graphene and the sulfur creates covalent bonding between the electrodes (702) and (704) and their respective coatings (734) and (764). The respective work function values of the electrodes (702) and (704) can be made to differ, even when both are comprised of graphene, for example by incorporating different coatings (734) and (764) into the electrodes (702) and (704). Suitable graphene electrodes are available through ACS (Advanced Chemical Suppliers) Materials, and include Trivial Transfer Graphene™ (TTG 10055).

In an embodiment, the surface area coverage on the emitter electrode (702) or the collector electrode (704) with Cs₂O is spatially resolved, e.g., applied in a pattern or non-uniform across the length of the corresponding surface, and provides a reduction in a corresponding work function to a minimum value. In an exemplary embodiment, the work function value, from a maximum of about 2.0 eV is reduced approximately 60-80% corresponding to the surface coverage of the Cs₂O, e.g. cesium oxide. The lower work function values of the electrodes (702) and (704) improve operation of the thermal energy harvesting thermionic device (700) as described herein.

Platinum (Pt)-coated on copper foil and aluminum (Al) materials optionally are selected for the first and second electrodes (702) and (704), respectively, due to at least some of their metallic properties, e.g., strength and resistance to corrosion, and the measured change in work function values when the thermionic emissive material of Cs₂O or other materials disclosed herein is layered thereon. Alternative materials may be used, such as graphene, noble metals including, and without limitation, rhenium (Re), osmium (Os), ruthenium (Ru), iridium (Ir), rhodium (Rh), and palladium (Pd), or any combination of these metals. In addition, and without limitation, non-noble metals such as gold (Au), tungsten (W), tantalum (Ta), and molybdenum (Mo), and combinations thereof, may also be used. For example, and without limitation, tungsten (W) nanoparticles may be used rather than platinum (Pt) nanoparticles to form the first surface (732), and gold (Au) nanoparticles may be used rather than aluminum (Al) nanoparticles to form the second surface (762). Accordingly, the selection of the materials used to form the nanoparticle surfaces (732) and (762) can be principally based on the work functions of the electrodes (702) and (704), and more specifically, the difference in the work functions once the electrodes (702) and (704) are fully fabricated.

The selection of the first and second coatings (734) and (764), e.g., thermionic electron emissive material, on the first surface (732) and second surface (762), respectively, may be partially based on the desired work function value of the electrodes (702) and (704), respectively, and chemical compatibility between the deposited materials, and the deposited thermionic electron emissive materials of the first and second coatings (734) and (764), respectively. Deposition materials include, but are not limited to, thorium, aluminum, cerium, and scandium, as well as oxides of alkali or alkaline earth metals, such as cesium, barium, calcium, and strontium, as well as combinations thereof and combinations with other materials. In at least one embodiment, the thickness of the layer of patterned thermionic electron emissive material of the first and second coatings (734) and (764) is approximately 2 nm, where the 2 nm value should be considered non-limiting. Accordingly, the electrodes (702) and (704) have highly desirable work functions.

Exemplary electrospray and nano-fabrication technique(s) and associated equipment, including three-dimensional printing and four-dimensional printing (in which the fourth dimension is varying the nanoscale composition during printing to tailor properties) for forming the first layer/first nanoparticle layer (718), the second layer/second nanoparticle layer (748), the spacer (706) and other layers and coatings discussed herein, including those of the device (700), are set forth in U.S. Application Publication No. 2015/0251213. Generally, that application publication discloses a composition including a nano-structural material, grain growth inhibitor nanoparticles, and at least one of a tailoring solute or tailoring nanoparticles. Any one or more of those compositional components (e.g., grain growth inhibitors) may be excluded from the embodiments described herein.

A simplified diagram of an electrospray apparatus or system is generally designated by reference numeral (1700) in FIG. 17. The electrospray system (1700) includes an outer housing (1702) that may be embodied as a vented heat shield containing a Faraday cage (not shown). Within the outer housing (1702), an emitter tube (also referred to as an electrospray nozzle) (1704) coupled to the bottom of a material reservoir (not shown) receives molten material from the material reservoir through a capillary tube (not shown). An extractor electrode (1706) is configured for generating an electric field (1708) to extract the molten material from the electrospray nozzle (1704) to form a stream or spray (1710) of droplets of nanoparticle size. The electric field (1708) also drives the spray of droplets (1710) towards a moving stage (1712) that is movable relative to the extractor electrode (1706). The extractor electrode (1706) can also generate a magnetic field for limiting dispersion of the stream (1710) of droplets. In an exemplary embodiment, the extractor electrode (1706) has a toroidal shape, with the electrospray nozzle (1704) extending through the center of the toroid. FIG. 17 shows the use of a template (1714) for forming a predetermined pattern on a substrate (1716). For example, the substrate (1716) can be the first layer (718) of the emitter electrode (702) or the second layer (748) of the collector electrode (706) of FIG. 7. The template (1714) can be used to control the deposition of the coating (734) or (764), e.g., a cesium oxide coating.

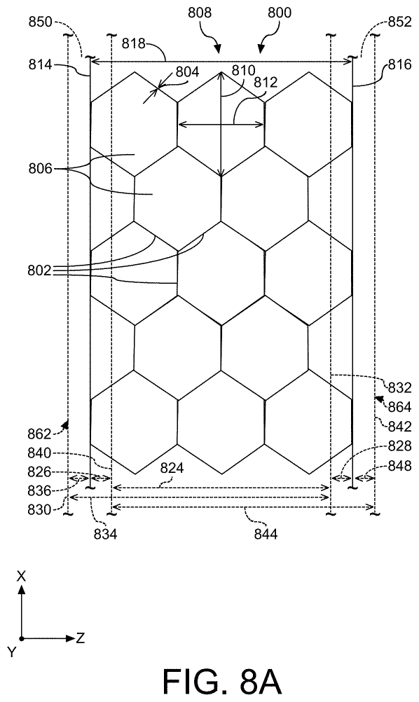

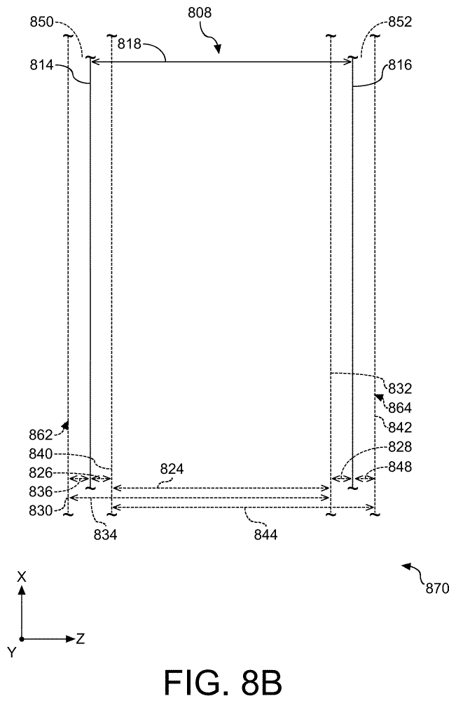

FIG. 8A depicts a top view of an embodiment of a spacer (800) in relationship to (between) the adjacent electrodes (862) and (864), for use in a thermal energy harvesting thermionic device, such as the device (700) having electrodes (702) and (704) as shown and described in reference to FIG. 7. The spacer (800) and the electrodes (862) and (864) are not shown to scale.

The spacer (800) includes a plurality of interconnected edges (802). The edges (802) have a thickness or edge measurement (804) in the range of, for example, about 2.0 nm to about 0.25 mm. In the illustrated embodiment, the interconnected edges (802) collectively define a plurality of hexagonal apertures, also referred to herein as cavities (806), in a honeycomb array (808). The cavities (806) extend in a direction parallel to the Y-axis. The spacer (800) may be configured as a uniform or relatively uniform layer, e.g., contiguous and with or without limited apertures. The apertures or cavities, either uniformly or non-uniformly provided across the width and/or length of the spacer material, may be in a range of, for example, greater than 0 mm (e.g., 2 nm) to about 0.25 mm in the Y-axis direction, similar to an embodiment of the spacer (706) of FIG. 7.

Referring to FIG. 8B, a top view of another embodiment of a spacer (870) between the adjacent electrodes (862) and (864), is shown for use in a thermal energy harvesting thermionic device, such as the device (700) with electrodes (702) and (704) as shown and described in FIG. 7. The embodiments shown and described in FIGS. 8A and 8B are provided with the same reference numerals, where appropriate, to designate identical or like parts. The spacer (870) may be comprised of a permeable or semi-permeable material, which in an embodiment may be adapted to receive or be coated or impregnated with the nano-fluid.

Referring to FIG. 8A, in an embodiment the apertures (806) have a first dimension (810) and a second dimension (812) each having a value in a range between, for example, 2.0 nm and 100 microns. In an embodiment, the edges (802), the apertures (806), and the array (808) form various shapes, configurations, and sizes, including the dimensions and sizing of the apertures (806), that enable operation of spacer (800) as described herein, including, without limitation, circular, rectangular, and elliptical apertures (806).

The spacers (800) and (870), shown in FIGS. 8A and 8B, respectively, include a first outer edge (814) and a second outer edge (816) that define the Z-dimensions of the spacer (800), (870). The spacer (800), (870) has a distance measurement (818) in the lateral dimension (Z) between the lateral side edges (814) and (816) in a range of, for example, about 1 nm to about 10 microns.

As shown in FIGS. 8A and 8B, the electrodes (862) and (864) are offset in the lateral dimension Z with respect to one another and with respect to the spacer (800), (870). Specifically, the emitter electrode (862) includes opposite first and second lateral side edges (830) and (832) separated by a first distance (834). The collector electrode (864) includes opposite third and fourth lateral side edges (840) and (842) separated by a second distance (844). The values of the first and second distances (834) and (844) may be the same or different from one another, and may be within a range of, for example, approximately 10 mm to approximately 2.0 m.

With respect to the first electrode (862), the first lateral side edge (830) extends in the lateral direction Z beyond the first lateral support side edge (814) of the spacer (800), (870) by a third distance (836), and the second lateral support side edge (816) of the spacer (800), (870) extends in the lateral direction Z beyond the second lateral side edge (832) by a fourth distance (828).

With respect to the second electrode (864), the first lateral support side edge (814) of the spacer (800), (870) extends in the lateral direction Z beyond the third lateral side edge (840) by a fifth distance (826), and the fourth lateral side edge (842) extends in the lateral direction Z beyond the second lateral support side edge (816) of the spacer (800), (870) by a sixth distance (848).

In embodiments, the third distance (836), the fourth distance (828), the fifth distance (826), and the sixth distance (848) may be the same or different from one another and within a range of, for example, approximately 1.1 nm to approximately 10 microns. The spacer (800), (870) may have a lateral measurement (818) with respect to the Z-axis greater than lateral measurements (834) and (844) of the electrodes (862) and (864), respectively. The spacer design and measurements shown and described herein reduce a potential for electrodes, such as the electrodes (702) and (704), to contact one another when the spacer (800), (870) is incorporated into the device (700) of FIG. 7. The direct contacting of the electrodes (702) and (704) would create a short circuit.

Each of the lateral support side edges (814) and (816) may receive at least one layer of an electrically insulating sealant that electrically isolates the portions (850) and (852) of the electrodes (862) and (864), respectively, that extend beyond the lateral support side edges (814) and (816), respectively. Further, as described above, each of the electrodes (862) and (864) may be offset from the spacer (800), (870) to reduce the potential for the electrodes (862) and (864) contacting each other and creating a short circuit.

In exemplary embodiments, the at least one spacer (800) and/or (870), which in exemplary embodiments are dielectric spacers, as shown and described in FIGS. 8A and 8B, respectively, are fabricated with a dielectric material, such as, and without limitation, silica (silicon dioxide), alumina (aluminum dioxide), titania (titanium dioxide), and boron-nitride. The apertures (806) extend between the electrodes (862) and (864) for the distance (710) (with reference to FIG. 7), e.g., in the Y-dimension, in a range of, for example, about 1 nanometer (nm) to about 10 microns. A fluid, e.g., the nano-fluid (712) of FIG. 7, is received and maintained within each of the apertures (806). The dielectric spacer (800), (870) is positioned between, and in direct contact with, the electrodes (862) and (864).

Referring to FIG. 9, a diagram (900) is provided to illustrate a schematic view of an embodiment of a fluid or medium (902), also referred to herein as a nano-fluid. As shown, the nano-fluid (902) includes a plurality of gold (Au) nanoparticle clusters (904) and a plurality of silver (Ag) nanoparticle clusters (906) suspended in a dielectric medium (908). In FIG. 9, each cluster (906) and (908) is embodied as a single nanoparticle, in particular a single Au nanoparticle or a single Ag nanoparticle, with a dielectric coating (discussed below). In some embodiments, and without limitation, the dielectric medium (908) is an alcohol, a ketone (e.g., acetone), an ether, a glycol, an olefin, and/or an alkane (e.g., those alkanes with greater than three carbon atoms, e.g., tetradecane). In an embodiment, the dielectric medium (908) is water or silicone oil. Alternatively, the dielectric medium (908) is a sol-gel with aerogel-like properties and low thermal conductivity values that reduce heat transfer therethrough, e.g., thermal conductivity values as low as 0.013 watts per meter-degrees Kelvin (W/m·K) as compared to the thermal conductivity of water at 20 degrees Celsius (° C.) of 0.6 W/m·K. Appropriate materials are selected to fabricate the nanoparticle clusters (904) and (906). The materials selected for the nanoparticle clusters (904) and (906) may have work function values that are greater than the work function values for associated electrodes, such as the electrodes (702) and (704) of FIG. 7. For example, the work function values of the Au nanoparticle clusters (904) and the Ag nanoparticle clusters (906) are about 4.1 eV and 3.8 eV, respectively.

At least one layer of a dielectric coating (910), such as a monolayer of alkanethiol material, is deposited on the Au nanoparticle clusters (904) and the Ag nanoparticle clusters (906) to form a dielectric barrier thereon. In an exemplary embodiment, the deposit of the dielectric coating (910) is performed via electrospray. The alkanethiol material of the dielectric coating (910) includes, but is not limited to, dodecanethiol and/or decanethiol. Additionally or alternatively, the dielectric coating (910) may be a halogenoalkane or alkyl halide, in which one or more of the hydrogen atoms of the alkane are replaced by halogen atom(s), i.e., fluorine, chlorine, bromine, or iodine. The deposit of the dielectric coating (910), such as alkanethiol, reduces coalescence of the nanoparticle clusters (904) and (906). In at least one embodiment, the nanoparticle clusters (904) and (906) have a diameter in the range of about 1 nm to about 3 nm. In an exemplary embodiment, the nanoparticle clusters (904) and (906) have a diameter of about 2 nm. In an exemplary embodiment, the Au nanoparticle clusters (904) and the Ag nanoparticle clusters (906) are tailored to be electrically conductive with charge storage features (i.e., capacitive features), minimize heat transfer through associate spacer apertures, such as the spacer apertures (806) of FIG. 8A, with low thermal conductivity values, minimize ohmic heating, eliminate space charges in the spacer apertures (806), and prevent arcing. The plurality of Au nanoparticle clusters (904) and the Ag nanoparticle clusters (906) are suspended in the dielectric medium (908). Accordingly, the nano-fluid (902), including the suspended nanoparticle clusters (904) and (906), provides a conductive pathway for electrons to travel across the spacer apertures (708) of FIG. 7 and/or (806) of FIGS. 8A and 8B from, for example with reference to FIG. 7, the emitter electrode (702) to the collector electrode (704) through charge transfer. Accordingly, in at least one embodiment, a plurality of the Au nanoparticle clusters (904) and the Ag nanoparticle clusters (906) are mixed together in the dielectric medium (908) to form the nano-fluid (902), the nano-fluid (902) residing in the apertures (708) of FIG. 7 and/or the apertures (806) of FIG. 8A or the inter-electrode gap of FIG. 8B.

The Au nanoparticle clusters (904) according to exemplary embodiments are dodecanethiol functionalized gold nanoparticles. In exemplary embodiments, the AU nanoparticle clusters (904) have an average particle size of about 1 nm to about 3 nm, at about 2% (weight/volume (grams/ml)). According to exemplary embodiments, the Ag nanoparticle clusters (906) are dodecanethiol functionalized silver nanoparticles. In certain embodiments, the Ag nanoparticle clusters (906) have an average particle size of about 1 nm to about 3 nm, at about 0.25% (weight/volume percent). In an embodiment, the average particle size of both the Au and Ag nanoparticle clusters (904) and (906) is at or about 2 nm. The Au and Ag cores of the nanoparticle clusters (904) and (906) are selected for their abilities to store and transfer electrons. In an embodiment, a 50%-50% mixture of Au and Ag nanoparticle clusters (904) and (906) are used. However, a mixture in the range of 1-99% Au-to-Ag could be used as well. Electron transfers are more likely to occur between nanoparticle clusters (904) and (906) with different work functions. In an exemplary embodiment, a mixture of nearly equal (molar) numbers of two different nanoparticle clusters (904) and (906), e.g., Au and Ag, provides good electron transfer. Accordingly, nanoparticle clusters are selected based on particle size, particle material (with the associated work function values), mixture ratio, and electron affinity.

Conductivity of the nano-fluid (902) can be increased by increasing concentration of the nanoparticle clusters (904) and (906). The nanoparticle clusters (904) and (906) may have a concentration within the nano-fluid (902) of, for example, about 0.1 mole/liter to about 2 moles/liter. In at least one embodiment, the Au and Ag nanoparticle clusters (904) and (906) each have a concentration of at least 1 mole/liter. In at least one embodiment, a plurality of Au and Ag nanoparticle clusters (904) and (906) are mixed together in a dielectric medium (908) to form a nano-fluid (902), the nano-fluid (902) residing in, for example, the apertures (708) of FIG. 7, the apertures (806) of FIG. 8A, and/or the inter-electrode gap of FIG. 8B.

The stability and reactivity of colloidal particles, such as Au and Ag nanoparticle clusters (904) and (906), are determined largely by a ligand shell formed by the alkanethiol coating (910) adsorbed or covalently bound to the surface of the nanoparticle clusters (904) and (906). The nanoparticle clusters (904) and (906) tend to aggregate and precipitate, which can be prevented by the presence of a ligand shell of the non-aggregating polymer alkanethiol coating (910) enabling these nanoparticle clusters (904) and (906) to remain suspended. Adsorbed or covalently attached ligands can act as stabilizers against agglomeration and can be used to impart chemical functionality to the nanoparticle clusters (904) and (906). Over time, the surfactant nature of the ligand coatings is overcome and the lower energy state of agglomerated nanoparticle clusters is formed. Over time, agglomeration may occur due to the lower energy condition of nanoparticle cluster accumulation and occasional addition of a surfactant may be used. Examples of surfactants include, without limitation, Tween® 20 and Tween® 21.

In the case of the nano-fluid (902) of FIG. 9 substituted for the nano-fluid (712) of FIG. 7, electron transfer through collisions of the plurality of nanoparticle clusters (904) and (906) is illustrated. The work function values of the nanoparticle clusters (904) and (906) are much greater than the work function values of the emitter electrode (702) (e.g., about 0.5 eV to about 2.0 eV) and the collector electrode (704) (e.g., about 0.5 eV to about 2.0 eV). The nanoparticle clusters (904) and (906) are tailored to be electrically conductive with capacitive (i.e., charge storage) features while minimizing heat transfer therethrough. Accordingly, the suspended nanoparticle clusters (904) and (906) provide a conductive pathway for electrons to travel across the apertures (708) from the emitter electrode (702) to the collector electrode (704) through charge transfer.

Thermally-induced Brownian motion causes the nanoparticle clusters (904) and (906) to move within the dielectric medium (908), and during this movement the nanoparticle clusters (904) and (906) occasionally collide with each other and with the electrodes (702) and (704). As the nanoparticle clusters (904) and (906) move and collide within the dielectric medium (908), the nanoparticle clusters (904) and (906) chemically and physically transfers charge. The nanoparticle clusters (904) and (906) transfer charge chemically when electrons (912) hop between electrodes, e.g., from and to the electrodes (702) and (704) of FIG. 7, to the nanoparticle clusters (904) and (906) and from one nanoparticle cluster (904) and (906) to another nanoparticle cluster. The hops primarily occur during collisions. Due to the electric field affecting the collector electrode (704), electrons (912) are more likely to move from the emitter electrode (702) to the collector electrode (704) via the nanoparticle clusters (904) and (906) rather than in the reverse direction. Accordingly, a net electron current from the emitter electrode (702) to the collector electrode (704) via the nanoparticle clusters (904) and (906) is the primary and dominant current of the thermal energy harvesting thermionic device (700).

The nanoparticle clusters (904) and (906) transfer charge physically (i.e., undergo transient charging) due to the ionization of the nanoparticle clusters (904) and (906) upon receipt of an electron, and the electric field generated by the differently charged electrodes (702) and (704). The nanoparticle clusters (904) and (906) become ionized in collisions when they gain or lose an electron (912). Positive and negative charged nanoparticle clusters (904) and (906) in the nano-fluid (902) migrate to the negatively charged collector electrode (704) and the positively charged emitter electrode (702), respectively, providing an electrical current flow. This ion current flow is in the opposite direction from the electron current flow, but less in magnitude than the electron flow.

Some ion recombination in the nano-fluid (902) may occur, which diminishes both the electron and ion current flow. Electrode separation may be selected at an optimum width (or thickness in the Y direction in FIG. 7) to maximize ion formation and minimize ion recombination. In an exemplary embodiment, the electrode separation (710) is less than about 10 nm to support maximization of ion formation and minimization of ion recombination. In an embodiment, the nanoparticle clusters (904) and (906) have a maximum dimension of, for example, about 2 nm. The electrode separation distance (710) as defined by the spacer (706) (or the spacer (800) or (870) of FIGS. 8A and 8B, respectively) has an upper limit of, for example, about 1000 nm, preferably about 100 nm, and more preferably about 20 nm, and the electrode separation distance (710) of 20 nm is equivalent to approximately 10 nanoparticle clusters (904) and (906). Therefore, the electrode separation distance (710) of about 20 nm provides sufficient space within the apertures (708) for nanoparticle clusters (904) and (906) to move around and collide, while minimizing ion recombination. For example, in an embodiment, an electron can hop from the emitter electrode (702) to a first set of nanoparticle clusters (904) and (906) and then to a second, third, fourth, or fifth set of nanoparticle clusters (904) and (906) before hopping to the collector electrode (704). A reduced quantity of hops mitigates ion recombination opportunities. Accordingly, ion recombination in the nano-fluid (902) is minimized through an electrode separation distance (710) selected at an optimum width to maximize ion formation and minimize ion recombination.

In an exemplary embodiment, when the emitter electrode (702) and the collector electrode (704) are initially brought into close proximity, the electrons of the collector electrode (704) have a higher Fermi level than the electrons of the emitter electrode (702) due to the lower work function of the collector electrode (704). The difference in Fermi levels drives a net electron current that transfers electrons from the collector electrode (704) to the emitter electrode (702) until the Fermi levels are equal, i.e., the electrochemical potentials are balanced and thermodynamic equilibrium is achieved. The transfer of electrons between the emitter electrode (702) and the collector electrode (704) results in a difference in charge between the emitter electrode (702) and the collector electrode (704). This charge difference sets up the voltage of the contact potential difference and an electric field between the emitter electrode (702) and the collector electrode (704), where the polarity of the contact potential difference is determined by the material having the greatest work function. With the Fermi levels equalized, no net current will flow between the emitter electrode (702) and the collector electrode (704). Accordingly, electrically coupling the emitter electrode (702) and the collector electrode (704) with no external load results in attaining the contact potential difference between the electrodes (702) and (704) and no net current flow between the electrodes (702) and (704) due to attainment of thermodynamic equilibrium between the two electrodes (702) and (704).

The thermal energy harvesting thermionic device (700) can generate electric power (e.g., at room temperature) with or without additional heat input. Heat added to the emitter electrode (702) will raise the temperature of the emitter electrode (702) and the Fermi level of the emitter electrode (702) electrons. With the Fermi level of the emitter electrode (702) higher than the Fermi level of the collector electrode (704), a net electron current will flow from the emitter electrode (702) to the collector electrode (704) through the nano-fluid (712), (902). If the device (700) is placed into an external circuit, such that the external circuit is connected to the electrodes (702) and (704), the same amount of electron current will flow through the external circuit from the collector electrode (704) to the emitter electrode (702). Heat energy added to the emitter electrode (702) is carried by the electrons (912) to the collector electrode (702). The bulk of the added energy is transferred to the external circuit for conversion to useful work, some of the added energy is transferred through collisions of the nanoparticle clusters (904) and (906) with the collector electrode (704), and some of the added energy is lost to ambient as waste energy. As the energy input to the emitter electrode (702) increases, the temperature of the emitter electrode (702) increases, and the electron transmission from the emitter electrode (702) increases, thereby generating more electron current. As the emitter electrode (702) releases electrons onto the nanoparticle clusters (904) and (906), energy is stored in the thermal energy harvesting thermionic device (700). Accordingly, the thermal energy harvesting thermionic device (700) generates, stores, and transfers charge and moves heat energy associated with a temperature difference, where added thermal energy causes the production of electrons to increase from the emitter electrode (702) into the nano-fluid (712), (902).

The nano-fluid (902) can be substituted into the device (700) of FIG. 7 and used to transfer charges from the emitter electrode (702) to one of the mobile nanoparticle clusters (904) and (906) via intermediate contact potential differences from the collisions of the nanoparticle cluster (904) and (906) with the emitter electrode (702) induced by Brownian motion of the nanoparticle clusters (904) and (906). Selection of dissimilar nanoparticle clusters (904) and (906) that include Au nanoparticle clusters (904) and Ag nanoparticle clusters (906), which have greater work functions of about 4.1 eV and about 3.8 eV, respectively, than the work functions of the electrodes (702) and (704), improves transfer of electrons to the nanoparticle clusters (904) and (906) from the emitter electrode (702) to the collector electrode (704). This relationship of the work function values of the Au and Ag nanoparticle clusters (904) and (906) improves the transfer of electrons to the nanoparticle clusters (904) and (906) through Brownian motion and electron hopping. Accordingly, the selection of materials within the thermal energy harvesting thermionic device (700) improves electric current generation and transfer therein through enhancing the release of electrons from the emitter electrode (702) and the conduction of the released electrons across the nano-fluid (712), (902) to the collector electrode (704).

As the electrons (912) hop from nanoparticle cluster (904) and (906) to nanoparticle cluster (904) and (906), single electron charging effects that include the additional work required to hop an electron (912) onto a nanoparticle cluster (904) and (906) if an electron (912) is already present on the nanoparticle cluster (904) and (906), determine if hopping additional electrons (912) onto that particular nanoparticle cluster (904) and (906) is possible. Specifically, the nanoparticle clusters (904) and (906) include a voltage feedback mechanism that prevents the hopping of more than a predetermined number of electrons to the nanoparticle cluster (904) and (906). This prevents more than the allowed number of electrons (912) from residing on the nanoparticle cluster (904) and (906) simultaneously. In an embodiment, only one electron (912) is permitted on any nanoparticle cluster (904) and (906) at any one time. Therefore, during conduction of current through the nano-fluid (902), a single electron (912) hops onto the nanoparticle cluster (904) and (906). The electron (912) does not remain on the nanoparticle cluster (904) and (906) indefinitely, but hops off to either the next nanoparticle cluster (904) and (906) or the collector electrode (704) through collisions resulting from the Brownian motion of the nanoparticle clusters (904) and (906). However, the electron (912) does remain on the nanoparticle cluster (904) and (906) long enough to provide the voltage feedback required to prevent additional electrons (912) from hopping simultaneously onto the nanoparticle clusters (904) and (906). The hopping of electrons (912) across the nanoparticle clusters (904) and (906) avoids resistive heating associated with current flow in a media. Notably, the thermal energy harvesting thermionic device (700) containing the nano-fluid (902) does not require pre-charging by an external power source in order to introduce electrostatic forces. This is due to the device (700) being self-charged with triboelectric charges generated upon contact between the nanoparticle clusters (904) and (906) due to Brownian motion. Accordingly, the electron hopping across the nano-fluid (902) is limited to one electron (912) at a time residing on a nanoparticle cluster (904) and (906).

As the electron current starts to flow through the nano-fluid (902), a substantial energy flux away from the emitter electrode (702) is made possible by the net energy exchange between emitted and replacement electrons (912). The replacement electrons from an electrical conductor connected to the emitter electrode (702) do not arrive with a value of energy equivalent to an average value of the Fermi energy associated with the material of emitter electrode (702), but with an energy that is lower than the average value of the Fermi energy. Therefore, rather than the replacement energy of the replacement electrons being equal to the chemical potential of the emitter electrode (702), the electron replacement process takes place in the available energy states below the Fermi energy in the emitter electrode (702). The process through which electrons are emitted above the Fermi level and are replaced with electrons below the Fermi energy is sometimes referred to as an inverse Nottingham effect. Accordingly, a low work function value of, for example, about 0.5 eV for the emitter electrode (702) allows for the replacement of the emitted electrons with electrons with a lower energy level to induce a cooling effect on the emitter electrode (702).

As described this far, the principal electron transfer mechanism for operation of the device (700) is thermionic energy conversion or harvesting. In some embodiments, thermoelectric energy conversion is conducted in parallel with the thermionic energy conversion. For example and referring to FIG. 9, an electron (912) colliding with a nanoparticle cluster (904) and (906) with a first energy may induce the emission of two electrons at second and third energy levels, respectively, where the first energy level is greater than the sum of the second and third energy levels. In such circumstances, the energy levels of the emitted electrons are not as important as the number of electrons.

A plurality of thermal energy harvesting thermionic devices (700) is distinguished by at least one embodiment having the thermoelectric energy conversion features described herein. The nano-fluid (712), (902) is selected for operation of the thermal energy harvesting thermionic devices (700) within one or more temperature ranges. In an embodiment, the temperature range of the associated thermal energy harvesting thermionic device (700) is controlled to modulate a power output of the device (700). In general, as the temperature of the emitter electrode (702) increases, the rate of thermionic emission therefrom increases. The operational temperature ranges for the nano-fluid (902) are based on the desired output of the thermal energy harvesting thermionic device (700), the temperature ranges that optimize thermionic conversion, the temperature ranges that optimize thermoelectric conversion, and fluid characteristics. Therefore, different embodiments of the nano-fluid (902) are designed for different energy outputs of the device (700).

For example, in an embodiment, the temperature of the nano-fluid (712), (902) is maintained at less than 250° C. to avoid deleterious changes in energy conversion due to the viscosity changes of the dielectric medium (908) above 250° C. In an embodiment, the temperature range of the nano-fluid (902) for substantially thermionic emission is only approximately room temperature (i.e., about 20° C. to about 25° C.) up to about 70-80° C., and the temperature range of the nano-fluid (902) for thermionic and thermo-electric conversion is above 70-80° C., with the principal limitations being the temperature limitations of the materials. In an exemplary embodiment, the nano-fluid (902) for operation including thermoelectric conversion includes a temperature range that optimizes the thermoelectric conversion through optimizing the power density within the thermal energy harvesting thermionic device (700), thereby optimizing the power output of the device (700). In at least one embodiment, a mechanism for regulating the temperature of the nano-fluid (902) includes diverting some of the energy output, e.g., heat, of the device (700) into the nano-fluid (902). Accordingly, the apertures (708) of specific embodiments of the thermal energy harvesting thermionic device (700) may be filled with the nano-fluid (902) to employ thermoelectric energy conversion with thermionic energy conversion above a particular temperature range, or thermionic energy conversion by itself below that temperature range.

As described herein, in at least one embodiment, the dielectric medium (908) has thermal conductivity values less than about 1.0 watt per meter-Kelvin (W/m·K). In at least one embodiment, the thermal conductivity of the dielectric medium (908) is about 0.013 watt per meter-Kelvin (W/m·K), as compared to the thermal conductivity of water at about 20 degrees Celsius (° C.) of about 0.6 W/m·K. Accordingly, the nano-fluid (902) minimizes heat transfer, such as through the apertures (708) of FIG. 7, with low thermal conductivity values. Since the heat transport in a low thermal conductivity nano-fluid (902) can be small, a high temperature difference between the two electrodes, e.g., the electrodes (702) and (704), can be maintained during operation. These embodiments are designed for thermal energy harvesting thermionic devices that employ thermionic emission where minimal heat transfer through the nano-fluid (712), (902) is desired.

As shown in FIG. 7, the thermal energy harvesting thermionic device (700) has an aperture (708) with a distance (710) between electrodes (702) and (704) that is within a range of, for example, about 1 nm to about 20 nm. In a portion of range of the electrode separation distance (710) of about 1 nm to about less than 10 nm, thermal conductivity values and electrical conductivity values of the nano-fluid (712), (902) are enhanced beyond those conductivity values attained when the predetermined distance of the cavity (708) is greater than about 100 nm. This enhancement of thermal and electrical conductivity values of the nano-fluid (712), (902) associated with the distance (710) of about 1 nm to 10 nm as compared to a distance (710) greater than 100 nm is due to a plurality of factors.

Examples of a first factor include, but are not limited to, enhanced phonon and electron transfer between the plurality of nanoparticle clusters (904) and (906) within the nano-fluid (902), enhanced phonon and electron transfer between the plurality of nanoparticle clusters (904) and (906) and the first electrode (702), and enhanced phonon and electron transfer between the plurality of nanoparticle clusters (904) and (906) and the second electrode (704).

A second factor is an enhanced influence of Brownian motion of the nanoparticle clusters (904) and (906) in a confining environment between the electrodes (702) and (704) to, e.g., less than about 10 nm inter-electrode distance (710). As the distance (710) between the electrodes (702) and (704) decreases below about 10 nm, fluid continuum characteristics of the nano-fluid (712), (902) with the suspended nanoparticle clusters (904) and (906) is altered. For example, as the ratio of particle size to volume of the apertures (708) increases, random and convection-like effects of Brownian motion in a dilute solution dominate. Therefore, collisions of the nanoparticle clusters (904) and (906) with the surfaces of other nanoparticle clusters (904) and (906) and the electrodes (702) and (704) increase thermal and electrical conductivity values due to the enhanced phonon and electron transfer.

A third factor is the at least partial formation of matrices of the nanoparticle clusters (904) and (906) within the nano-fluid (902). Under certain conditions, the nanoparticle clusters (904) and (906) will form matrices within the nano-fluid (902) as a function of close proximity to each other with some of the nanoparticle clusters (908) remaining independent from the matrices. In an embodiment, the formation of the matrices is based on the factors of time and/or concentration of the nanoparticle clusters (904) and (906) in the nano-fluid (902).

A fourth factor is the predetermined nanoparticle clusters (904) and (906) density, which in an embodiment is about one mole per liter. Accordingly, apertures (708) containing the nano-fluid (902) with a distance (710) of about 1 nm to less than about 10 nm causes an increase in the thermal and electrical conductivity values of the nano-fluid (902) therein.

In addition, the nanoparticle clusters (904) and (906) have a small characteristic length, e.g., about 2 nm, and the clusters (904) and (906) are often considered to have only one dimension. This characteristic length restricts electrons in a process called quantum confinement, which increases electrical conductivity. The collision of particles with different quantum confinement facilitates transfer of charge to the electrodes (702) and (704). The thermal energy harvesting thermionic device (700) has an enhanced electrical conductivity value greater than about 1 Siemens per meter (S/m) as compared to the electrical conductivity of drinking water of about 0.005 S/m to about 0.05 S/m. Also, the embodiments of the device (700) with the enhanced thermal conductivity have a thermal conductivity value greater than about 1 W/m·K as compared to the thermal conductivity of water at 20 degrees Celsius (° C.) of about 0.6 W/m·K.

Thermionic emission of electrons (912) from the emitter electrode (702) and the transfer of the electrons (912) across the nano-fluid (902) from one nanoparticle cluster (904) and (906) to another nanoparticle cluster (904) and (906) through hopping are both quantum mechanical effects.

Release of electrons from the emitter electrode (702) through thermionic emission as described herein is an energy selective mechanism. A thermionic barrier in the apertures (708) between the emitter electrode (702) and the collector electrode (704) is induced through the interaction of the nanoparticles (904) and (906) inside the apertures (708) with the electrodes (702) and (704). The thermionic barrier is at least partially induced through the number and material composition of the plurality of nanoparticle clusters (904) and (906). The thermionic barrier induced through the nano-fluid (902) provides an energy selective barrier on the order of magnitude of about 1 eV. Accordingly, the nano-fluid (902) provides an energy selective barrier to electron emission and transmission.

To overcome the thermionic barrier and allow electrons (912) to be emitted from the emitter electrode (702) above the energy level needed to overcome the barrier, materials for the emitter electrode (702) and the collector electrode (704) are selected for their work function values and Fermi level values. The Fermi levels of the two electrodes (702) and (704) and the nanoparticle clusters (904) and (906) will try to align by tunneling electrons (912) from the electrodes (702) and (704) to the nanoparticle clusters (904) and (906). The difference in potential between the two electrodes (702) and (704) (described elsewhere herein) overcomes the thermionic barrier, and the thermionic emission of electrons (912) from the emitter electrode (702) occurs with sufficient energy to overcome the thermionic block. Notably, and in general, for cooling purposes, removing higher energy electrons from the emitter electrode (702) causes the emission of electrons (912) to carry away more heat energy from the emitter electrode (702) than is realized with lower energy electrons. Accordingly, the energy selective barrier is overcome through the thermionic emission of electrons at a higher energy level than would be otherwise occurring without the thermionic barrier.

Once the electrons (912) have been emitted from the emitter electrode (702) through thermionic emission, the thermionic barrier continues to present an obstacle to further transmission of the electrons (912) through the nano-fluid (902). Smaller inter-electrode gaps on the order of about 1 nm to about 10 nm, as compared to those gaps in excess of 100 nm, facilitate electron hopping, i.e., field emission, of short distances across the apertures (708). Energy requirements for electron hopping are much lower than the energy requirements for thermionic emission; therefore, the electron hopping has a significant effect on the energy generation characteristics of the device (700). The design of the nano-fluid (902) enables energy selective tunneling, e.g., electron hopping, that is a result of the barrier (which has wider gap for low energy electrons) which results in electrons above the Fermi level being a principal hopping component. In an exemplary embodiment, direction of the electron hopping is determined through the selection of the different materials for the electrodes (702) and (704) and their associated work function and Fermi level values. The electron hopping across the nano-fluid (902) transfers heat energy with electrons (912) across the apertures (708) while maintaining a predetermined temperature gradient such that the temperature of the nano-fluid (902) is relatively unchanged during the electron transfer. Accordingly, the emitted electrons transport heat energy from the emitter electrode (702) across the apertures (708) to the collector electrode (704) without increasing the temperature of the nano-fluid (902).

In an embodiment, the thermal energy harvesting thermionic device (700) is configurable with respect to the physical dimensions therein. In an exemplary embodiment, the device (700) has a length measurement, in a direction along the X-axis in FIG. 7, of approximately 6 inches, although other lengths are contemplated, and a width measurement, in a direction along the Z axis in FIG. 7, of approximately 6 inches, although other widths are contemplated. A thickness of the thermal energy harvesting thermionic device is approximately 0.005 mm to about 2.0 mm, for example about 1.0 mm. In an exemplary embodiment such measurements should not be considered limiting. For example, in an exemplary embodiment, the physical dimensions may be expanded or reduced to accommodate operational aspects of the device.

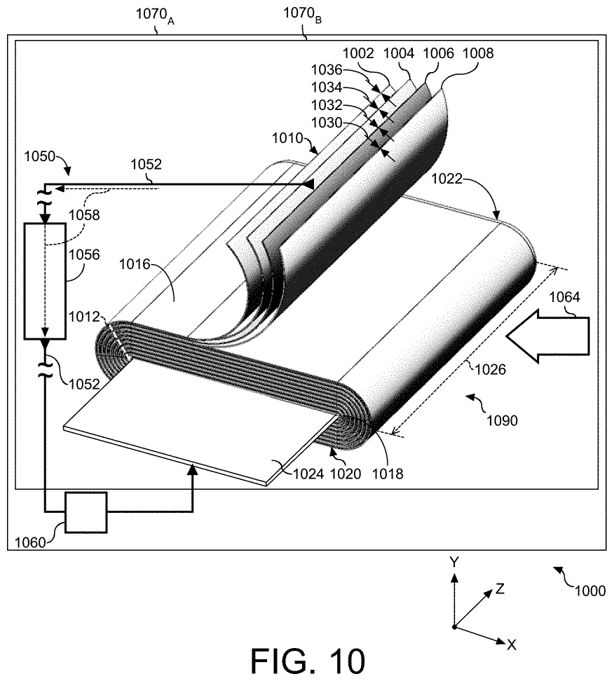

Referring to FIG. 10, a diagram (1000) is provided illustrating a schematic perspective view of an embodiment of a thermal energy harvesting thermionic device (1090) that may be incorporated into the respective apparatus of FIGS. 1-5. The thermal energy harvesting thermionic device (1090) is not shown to scale, and the circuit illustrated in FIG. 10 does not necessarily depict all features of FIGS. 1-5. The thermal energy harvesting thermionic device (1090) is manufactured with a plurality of layers of materials. In an embodiment, the thermal energy harvesting thermionic device (1090) is manufactured to include four layers. A first layer (1002) is referred to as a casing or sheathing that protects one or more of the inner layers and facilitates heat transfer in and out of the device (1090). In an embodiment, the first layer (1002) is manufactured from a thermally conductive and electrically insulating material. A second layer (1004) includes the emitter electrode, a third layer (1006) includes the separation material (also referred to herein as a standoff and spacer), and a fourth layer (1008) includes the collector electrode. In an embodiment, the third layer (1006) is referred to herein as a spacer. In exemplary embodiments, the emitter electrode (1004), the spacer (1006), and the collector electrode (1008) are fabricated and configured as shown and described in, for example, FIGS. 7-9. The separation material (1006), e.g., the third layer, contains nano-fluid, such as the nano-fluid (712) of FIG. 7 and (902) of FIG. 9, positioned in the apertures, e.g., (708) and (806). The outer casing (1002), i.e., the first layer, is in direct contact with the emitter electrode (1004), i.e., the second layer, and the emitter electrode (1004) and the collector electrode (1008), i.e., the fourth layer, are in direct contact with the spacer (1006). The layers (1002), (1004), (1006), and (1008) are shown peeled away for clarity. In an embodiment, the layers (1002), (1004), (1006), and (1008) define a composite structure configured as a sheet (1010). Accordingly, the outer casing (1002) is in contact with the emitter electrode (1004) to provide heat transfer, protective, and sealing features to the device (1090).

The thermal energy harvesting thermionic device (1090) is shown herein with an at least partially planar configuration with a defined radius (1012) extending from an end of an aperture (1018) to an outermost surface (1016) of the device (1090). It should be understood that various configurations may be practiced. As shown herein, the aperture (1018) has a planar or relatively planar geometric characteristic, and is hereinafter referred to as a planar aperture or slot. The planar aperture (1018) has geometric properties, including a first end area (1020) and an opposing second end area (1022), with the planar aperture extending (along a direction parallel to axis Z) from the first end area (1020) to the second end area (1022). In an embodiment, the distance between the first end area (1020) and the second end area (1022) is referred to as a first distance.

In an embodiment, a structural member (1024) is inserted into, received by, and positioned within the planar aperture (1018). In an embodiment, the structural member (1024) received by and positioned in the aperture (1018) extends beyond the area defined by the aperture (1018). In an embodiment, the structural member (1024) is fabricated from one or more materials that are both thermally and electrically conductive, as well as chemically compatible with the materials of the layers (1002), (1004), (1006), and (1008). In other embodiments, the structural member (1024) is fabricated from materials that are either thermally or electrically conductive. Accordingly, the structural member (1024) is configured with mechanical and electrical properties. Although the structural member (1024) is illustrated as a flat, e.g., planar, plate, it should be understood that the structural member (1024) may have other configurations.

The fourth layer (1008), i.e., the collector electrode, is electrically coupled to the structural member (1024) to provide at least a partial electrical flow path. The composite sheet (1010) extends from the structural member (1024) in a wrapped or rolled configuration, where the wrapped configuration has a common center defined by the planar aperture (1018) to further define a concentric configuration. The planar aperture (1018) imparts a toroidal configuration to the wrapped configuration of the composite sheet (1010). Accordingly, the at least partially planar thermal energy harvesting thermionic device (1090) has characteristics that are substantially toroidal.

In an embodiment, the thermal energy harvesting thermionic device (1090) has a first measurement (1026), referred to as length, of approximately 10 mm to about 2.0 m. Lengths outside this range are contemplated. A thickness of the composite layer (1010) (i.e., collective thickness of the layers (1002), (1004), (1006), and (1008)) is approximately 0.005 mm to about 2.0 mm. A thickness (1030) of the collector electrode (1008) is, for example, approximately 0.005 mm to less than 2.0 mm. A thickness (1032) of the spacer (1006) is, for example, approximately 1.0 nm to about 10 microns. A thickness (1034) of the emitter electrode (1004) is, for example, approximately 0.005 mm to less than 2.0 mm. A thickness (1036) of the outer casing (1002) is, for example, approximately 0.005 mm to less than 2.0 mm. The composite sheet (1010) is defined by a first measurement, which is referred to as a composite length, ranging from approximately 10 mm to 2.0 m, for example. Other embodiments include any dimensional characteristics that enable operation of the thermionic device (1090) as described herein.

As further shown, an electrical circuit (1050) is connected to the thermal energy harvesting thermionic device (1090). The circuit (1050) includes an electrical conductor (1052) that is electrically connected to the structural member (1024) that is electrically connected to the collector electrode (1008). The circuit (1050) further includes at least one electrical load (1056), such as a power-consumption device or a rechargeable power storage device (or the appliance) connected to the conductor (1052). When the thermal energy harvesting thermionic device (1090) is generating electricity, electrical current (1058) (using conventional flow notation) is transmitted through the circuit (1050) in an opposite direction to the electron current. As discussed above, the electrons flow within the device (1090) from the emitter electrode (1004) to the collector electrode (1008), then through the load (1056) back to the emitter electrode (1004). For example, a single device (1090) can generate a voltage within a range extending between about 0.5 volt and 1.0 volt, depending on the contact potential difference (discussed further herein) induced between the emitter electrode (1004) and the collector electrode (1008) as a function of the emitted and collector materials. In an embodiment, the device (1090) generates about 0.90 volt. In an embodiment, the device (1090) can generate an electrical current within a range of approximately 5 amperes (amps) to approximately 10 amps. In an embodiment, the device (1090) generates about 7.35 amps. Further, in an embodiment, the device (1090) generates approximately 2.5 watts to approximately 10 watts. In an embodiment, the device (1090) generates about 6.6 watts. A plurality of the devices (1090) may be electrically connected in series for a specific voltage or in parallel for a specific current, or in series and parallel to satisfy voltage, current, and power requirements. Accordingly, as described further herein, an arrangement of the devices (1090) is scalable to provide sufficient electrical power from the watt range to the megawatt range for a variety of applications.

The structural member (1024) performs both heat transfer and electrical conduction actions when the thermal energy harvesting thermionic device (1090) is in service generating electricity. The structural member (1024) is electrically coupled to the circuit (1050) to transmit the electrical power generated within the device (1090) along the conductor (1052) to the electrical load (1056).

In the embodiment shown in FIG. 10, the structural member (1024) is shown operably coupled to a heat dissipating device (1060), shown herein as a heat sink or a heat exchanger, which in an exemplary embodiment may be a microstructure array heat exchanger. In an embodiment the heat dissipating device (1060) is embodied in the manner illustrated in FIGS. 6A and 6B and described above. Specifically, the collector electrode (1008) is in direct contact with the structural member (1024). In an embodiment, the heat dissipating device (1060) is positioned between the structural member (1024) and the electrical load (1056), and optionally in contact with the structural member (1024), to cool the conductor (1052) and avoid thermal damage that could otherwise be caused by the transfer of thermal energy by the conductor (1052) to the electrical load (1056). In another exemplary embodiment, the heat transfer to air is adequate in ambient conditions, so that the use or need for a heat exchanger can be mitigated or eliminated. The heat dissipating device (1060) may be located internal or external to the housing, e.g., housing (112), (212), or (312), or at alternative locations along the electrical conductor (1052).

The thermal energy harvesting thermionic device (1090) generates electric power through harvesting heat energy (1064). As described in further detail herein, the emitter electrode (1004) receives heat energy (1064) from an appliance (e.g., (104), (204), (304), or (402) of FIGS. 1-4, respectively), and generates the electric current (1058), which is transmitted through the circuit (1050) to the load (1056).

In FIG. 10, reference numeral (1070_{A}) represents a first embodiment of an appliance housing. The appliance housing (1070_{A}) is shown enclosing the heat dissipating device (1060). Reference numeral (1070_{B}) in FIG. 10 represents a second embodiment of an appliance housing. The heat dissipating device (1060) is outside or external to the appliance housing (1070_{B}) in FIG. 10. It should be understood that other components shown internal to the housing (1070_{A}) or (1070_{B}) in FIG. 10 can be positioned external to the appliance housing (1070A) or (1070B).

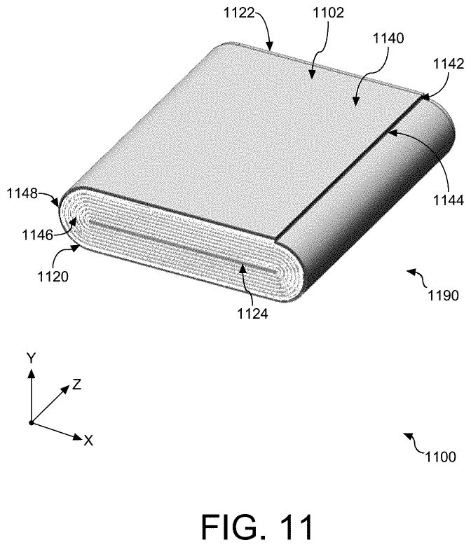

Referring to FIG. 11, a schematic drawing (1100) is provided illustrating a perspective view of a thermal energy harvesting thermionic device (1190) similar to the device (1090) of FIG. 10, but without a circuit. In an embodiment, an outer casing (1102) includes multiple layers (similar to layer (1002) of FIG. 10) of outer casing material to fabricate the outer casing (1102) with an enhanced robustness. The outer casing (1102) of the device (1190) includes an external surface (1140) that includes a seam (1142) defined by one or more layers (such as layer (1002) of FIG. 10) of the outer casing (1102). In an embodiment, the seam (1142) is defined by a composite structure, such as the composite structure (1010) of FIG. 10. The seam (1142) is shown receiving a sealant (1144) to prevent ingress of contaminants and egress of device materials through the seam (1142). In an embodiment, the sealant (1142) is non-conductive to prevent short circuiting, such as between the electrodes (1004) and (1008) of FIG. 10. In an embodiment, the sealant (1144) is antimony-based. In another embodiment, the sealant (1144) is a beryllium-based sealant. In still another embodiment, the sealant (1144) is a polymer-based sealant. In another embodiment, the sealant (1144) is manufactured from a material that does not impede or prevent operation of a thermal energy harvesting thermionic device (1190) as described herein.

A first end or base area (1120) receives a sealant (1146) that extends between a rim (1148) defined by the outer casing (1102) and a structural member (1124), which is the same as or similar to the structural member (1024) described above. In an embodiment, the sealant (1146) is substantially similar to the sealant (1144) with respect to composition and function. In an embodiment, the sealant (1146) is different from the sealant (1144). The sealant (1146) is also applied to a second end or base area (1122), oppositely disposed from the first end area (1120). In an embodiment, the second end area (1122) has a similar configuration to the first end area (1120). The sealant (1146) functions to protect electrodes (e.g., the electrodes (1004) and (1008)), spacer (e.g., the spacer (1006)), and nano-fluid (e.g., the nano-fluid (902)) from environmental factors, such as debris, that may induce a short circuit between electrodes (e.g., the electrodes (1004) and (1008)) or contaminate the nano-fluid (902).

In addition, as described herein with respect to FIG. 10, and described further with respect to FIGS. 8A and 8B, the electrodes (1004) and (1008) (equivalent to the electrodes (862) and (864), respectively) are offset distances (equivalent to distances (836) and (848), respectively), from the edges (814) and (816) of the spacer (1006). As shown in FIG. 11, the non-conducting sealant (1146) resides around the lateral side edges (similar to side edges (830) of the electrode (862) and the lateral side edges (842) of the electrode (864)) that extend distances (equivalent to distances (836) and (848)) beyond the spacer (800), (870)), respectively. Accordingly, the thermal energy harvesting thermionic device (1190) is shown herein with sealants (1144) and (1146) that provide environmental protection for the device (1190) and electrical insulation for the electrodes (1004) and (1008).

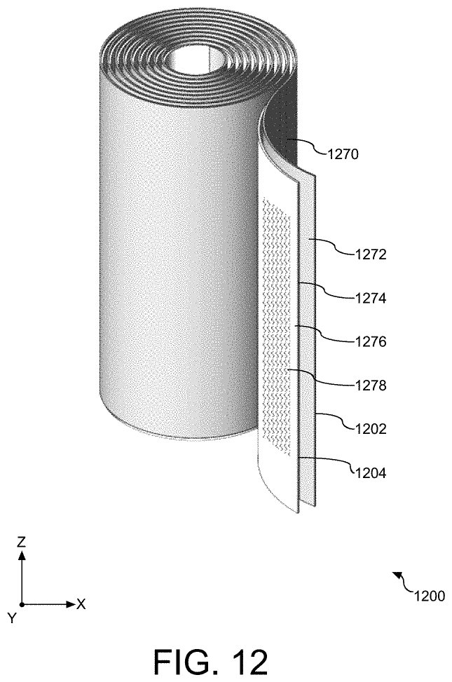

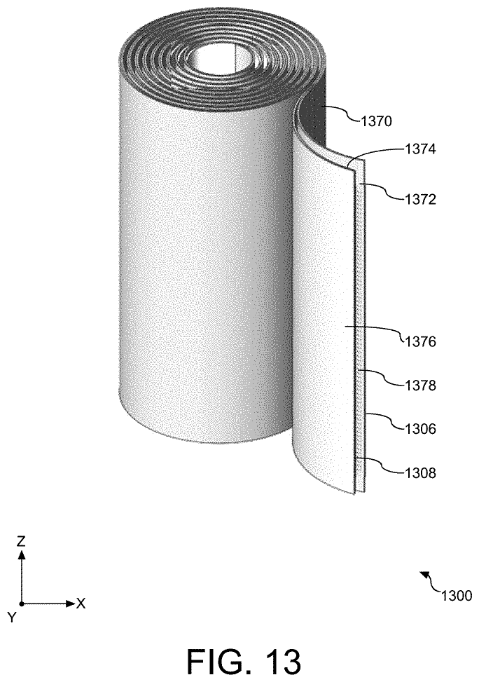

In an embodiment, the thermal energy harvesting thermionic device (700) is manufactured from different prefabricated materials. FIG. 12 shows a perspective view of a first repository or roll (1200) of layered materials (1202) and (1204), e.g., the first and second layers, that may be used to manufacture the thermal energy harvesting thermionic device (700). FIG. 13 illustrates a perspective view of a second repository or roll (1300) of layered materials (1306) and (1308), e.g., the third and fourth layers, that may be used in combination with the first repository (1200) to manufacture the thermal energy harvesting thermionic device (700).

Referring to FIG. 12, a first layer (1202) is equivalent to an outer casing of the thermal energy harvesting thermionic device, and is hereon referred to as outer casing (1202). The outer casing (1202) is the equivalent to the first backing (716) of FIG. 7. Similarly, a second layer (1204) is equivalent to the emitter electrode (718) and is hereon referred to as emitter electrode (1204). The outer casing (1202) includes a first surface (1270) that defines an external surface of the thermal energy harvesting thermionic device (700). The outer casing (1202) also includes a second surface (1272) that contacts the emitter electrode (1204). The emitter electrode (1204) includes a first surface (1274) contacting the second surface (1272) of the outer casing (1202). The emitter electrode (1204) also includes a second surface (1276). In an embodiment, the second surface (1276) is at least partially coated with Cs₂O (1278), which in an embodiment is pre-applied to the second surface (1276). In an embodiment, the Cs₂O (1278) is applied to the second surface (1276) during manufacturing of the thermal energy harvesting thermionic device.

Referring to FIG. 13, a third layer (1306) is equivalent to a separation material (such as the spacer 406) of FIG. 7), and is hereon referred to as separation material (1306). In an embodiment, the separation material (1306) is, e.g., a dielectric material, and the separation material (1306) is impregnated with a nano-fluid, such as nano-fluid (902) discussed herein. Similarly, a fourth layer (1308) is equivalent to a collector electrode and is hereon referred to as collector electrode (1308). The separation material (1306) includes a first surface (1370) that contacts the second surface (1276) of the emitter electrode (1204) of FIG. 12. The separation material (1306) also includes a second surface (1372). The collector electrode (1308) includes a first surface (1374) contacting the second surface (1372) of the separation material (1306). The collector electrode (1308) also includes an opposite second surface (1376). In an embodiment, the first surface (1374) is at least partially coated with Cs₂O (1378), which in an embodiment is pre-applied to the first surface (1374). In an embodiment, the Cs₂O (1378) is applied to the first surface (1374) during manufacturing of the thermal energy harvesting thermionic device.

In an embodiment, rather than manufacturing the thermal energy harvesting thermionic device using the two repositories or rolls (1200) and (1300), each of the layers (1202), (1204), (1306), and (1308) are dispensed from an individual repository or roll for each layer. In another embodiment, rather than using a separation material (1306) in the form of a solid material, the separation material (1306) is applied to either the second surface (1276) of the emitter electrode (1204) or the first surface (1374) of the collector electrode (1308). In an embodiment, the solid material is a sheet or a web. In an embodiment, the separation material (1306) is applied to both of the surfaces (1276) and (1374). In an embodiment, the separation material (1306) is pre-applied to the electrodes (1204) and (1308). In an embodiment, the separation material (1306) is applied to the electrodes (1204) and (1308) at the time of manufacture of the thermal energy harvesting thermionic device. In an embodiment, the separation material (1306) is a fluid applied through one or more electrospray devices (e.g., FIG. 17). In an embodiment, the separation material (1306) is applied through any method that enables operation of devices as described herein.

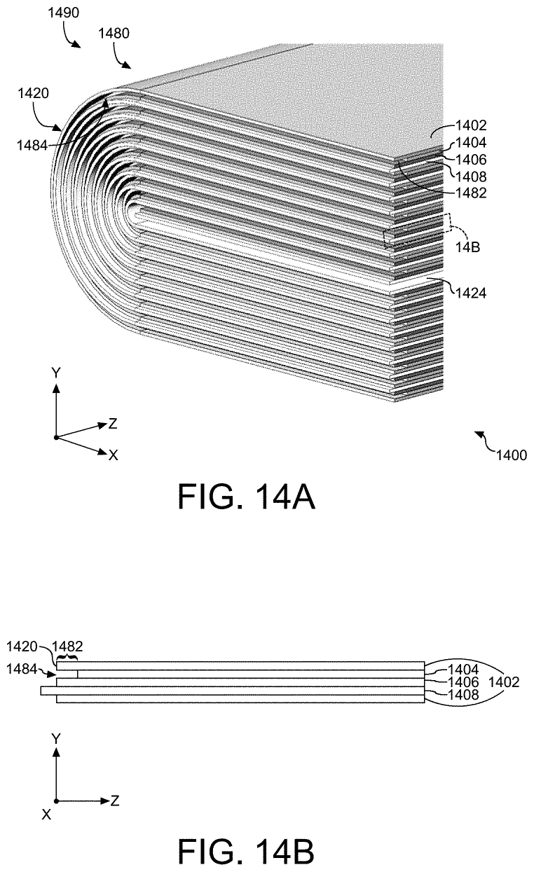

Referring to FIGS. 14A and 14B, a diagram (1400) is provided illustrating an enlarged perspective view of a first portion (1480) of a thermal energy harvesting thermionic device (1490) according to an embodiment. The device (1490) is constructed of a four-layer composite including the four layers of FIGS. 12 and 13, collectively, wound about a structural member (1424), which may be conductive. While shown as an oblong roll, it should be understood that the wound structure may be configured in other configurations, including as a rolled cylinder. An outer casing (1402), an emitter electrode (1404), a spacer (1406), and a collector electrode (1408) are shown stacked on one another to provide a composite structure, which in an embodiment is a sheet wrapped about the structure member (1424). As best shown in FIG. 14B, the emitter electrode (1404) is offset (1482) with respect to the spacer (1406). The emitter electrode (1404) is recessed or offset in the Z-dimension with respect to a first end base area (1420) at least partially defined by the outer casing (1402), the spacer (1406), and the collector electrode (1408). The depression or offset (1482) of the emitter electrode (1404) defines a cavity (1484) between each adjacent layer of the spacer (1406) and each adjacent layer of the outer casing (1402). In addition to the set back of the emitter electrode (1404), the collector electrode (1408) extends beyond the adjacent spacer (1406) in the Z-dimension. In an embodiment, rather than the emitter electrode (1404), the collector electrode (1408) is depressed or offset in the Z-dimension with respect to the first end base area (1420). In an embodiment, an edge of the collector electrode (1408) is approximately flush, e.g., co-planar, with the edge of the spacer (1406) to partially define the first base area (1420) with no offset. As described herein with respect to FIGS. 14A and 14B, a sealant may be applied to the end area (1420) to cover the ends (or edges) of the emitter and collector electrodes (1404) and (1408), respectively, proximate the end area (1420) and fill in the cavity (1484) with a non-conductive material to further electrical isolation between the electrodes (1404) and (1408) to prevent short circuiting.

FIG. 15 is a cross-sectional view of a thermal energy harvesting thermionic device, generally designated by reference numeral (1500), according to an exemplary embodiment. Unlike the wound embodiments described above in connection with FIGS. 10-14B, the thermal energy harvesting thermionic device (1500) of FIG. 15 comprises a plurality of harvester units (1501A), (1501B), and (1501C) layered/stacked on one another. The harvester units (1501A), (1501B), and (1501C) are serially connected to one another and separated from one another by insulating layers.

The first (top) harvester unit (1501A) includes an emitter electrode (cathode) (1502A) having a coating (1534A), a collector electrode (anode) (1504A) having a coating (1564A), and a chamber (or aperture) interposed between the electrodes (1502A) and (1504A) filled with nano-fluid (1508A) and surrounded on opposite sides by insulating spacers (1506A₁) and (1506A₂). The second (middle) harvester unit (1501B) includes an emitter electrode (cathode) (1502B) having a coating (1534B), a collector electrode (anode) (1504B) having a coating (1564B), and a chamber (or aperture) between the electrodes (1502B) and (1504B) filled with nano-fluid (1508B) and surrounded on opposite sides by insulating spacers (1506B₁) and (1506B₂). The third (bottom) harvester unit (1501C) includes an emitter electrode (cathode) (1502C) having a coating (1534C), a collector electrode (anode) (1504C) having a coating (1564C), and a chamber (or aperture) between the electrodes (1502C) and (1504C) filled with nano-fluid (1508C) and surrounded on opposite sides by insulating spacers (1506C₁) and (1506C₂).

A first insulating layer (1570A) is positioned above the first harvester unit (1501A). A second insulating layer (1570B) is interposed between the first harvester unit (1501A) and the second harvester unit (1501B). A third insulating layer (1570C) is interposed between the second harvester unit (1501B) and the third harvester unit (1501C). A conductive plate (1572) is positioned below the third harvester unit (1501C) as a thermal conductor for transmitting heat from the heat generating source (e.g., the appliance (104) of FIG. 1) to the thermal energy harvesting thermionic device (1500). In another embodiment, reference numeral (1572) may be the heat generating source, e.g., the appliance (104), (204), or (304) of FIGS. 1-3, respectively.

The emitter electrodes (cathodes) (1502A), (1502B), and (1502C) may be made of any of the materials described herein. In an exemplary embodiment, the emitter electrodes (1502A), (1502B), and (1502C) are made of a copper foil coated with platinum (Pt). The emitter electrode coatings (1534A), (1534B), and (1534C) may be comprised of cesium oxide. The emitter electrode coatings (1534A), (1534B), and (1534C) may cover, for example, about 60 to 80 percent of the surface area of their respective emitter electrodes. The collector electrodes (anodes) (1504A), (1504B), and (1504C) likewise may be made of any of the materials described herein. In an exemplary embodiment, the collector electrodes (1504A), (1504B), and (1504C) are made of tungsten foil. The collector electrode coatings (1564A), (1564B), and (1564C) may be comprised of cesium oxide. The collector electrode coatings (1564A), (1564B), and (1564C) may cover, for example, about 60 to about 80 percent of the surface area of their respective collector electrodes.

The nano-fluids (1508A), (1508B), and (1508C) may be, for example, any of the materials described above in connection with FIG. 9. In an exemplary embodiment, the nano-fluids (1508A), (1508B), and (1508C) include polymer-coated gold and silver nanoparticles. In an exemplary embodiment, the polymer coating of the nanoparticles is a halogenoalkane or alkyl halide, particularly those having boiling points above 220° C.

The insulating spacers (1506A₁), (1506A₂), (1506B₁), (1506B₂), (1506C₁), and (1506C₂) and the insulating layers (1570A), (1570B), and (1570C) may be comprised of, for example, an alkane-thiol. The spacers may have a multi-layer (e.g., five-layer) structure, with each layer at least one micron in thickness.

For the purposes of illustration, the thermal energy harvesting thermionic device (1500) has been shown with three thermionic units (1501A), (1501B), and (1501C) stacked on one another. It should be understood that the device (1500) may include fewer (two) or more thermionic units than shown. Although FIG. 15 has been discussed in connection with a serial (or daisy-chained) connection of the thermal energy harvesting thermionic units (1501A), (1501B), and (1501C), it should be understand that the units may be connected in parallel or serial-parallel. Further, the thermionic units (1501A), (1501B), and (1501C) may be positioned relative to one another in configurations other than the stacked configuration of FIG. 15. For example, the thermionic units (1501A), (1501B), and (1501C) may be positioned adjacent one another.

Referring to FIG. 16, a flowchart (1600) is provided illustrating a process according to an embodiment for making a thermal energy harvesting thermionic device and generating electric power with the thermal energy harvesting thermionic device. As described herein, a first electrode having a first work function value is provided (1602). A spacer or separation material with apertures is provided on the first electrode (1604). The apertures are filled with a fluid, in an exemplary embodiment a nano-fluid (1606). A second electrode having a second work function value is provided and positioned on the spacer (1608). In an exemplary embodiment, the work function value of the second electrode is less than the work function value of the first electrode. The first electrode and the second electrode are proximally positioned a predetermined distance from each other, i.e., about 1 nm to less than about 20 nm. A first surface of the separation material is positioned in at least partial physical contact with the first electrode, and an opposite second surface of the separation material is positioned in at least partial physical contact with the second electrode

An appliance is positioned proximal to the thermal energy harvesting thermionic device (1610). See FIGS. 1-4 and 5C for examples depicting positioning of the appliance with respect to the thermal energy harvesting thermionic device. An electrical conductive path is established between the thermionic device and a load to transfer electrical output from the thermionic device to the load (1612). A heat dissipating device is positioned to reduce the temperature of the electrical conductive path (1614). Heat is transmitted from the appliance to the thermionic device (1616), and a plurality of electrons is transmitted between the first and second electrodes via the nanoparticles to generate an electrical output (1618). The electrical output is supplied to the load along the electrically conductive path (1620) as the temperature of the electrically conductive path is reduced using the heat dissipating device (1622).

As described herein, exemplary embodiments are directed generally to an apparatus including an energy source, and more particularly is directed to a thermal energy harvesting thermionic device. Ionization is provided therein by the combination of electron tunneling and thermionic emission of the thermal energy harvesting thermionic device. Charge transfer therein is affected through conductive nanoparticles suspended in a fluid, i.e., a nano-fluid, undergoing collisions driven by thermally-induced Brownian motion. The design of the thermal energy harvesting thermionic device enables energy extraction from the heat generating source of the apparatus. To this end, the electrodes are proximally positioned to allow electrons to travel the distance between them. These electrons emitted at a wide range of temperatures proceed across the gap due to the nano-fluid providing a conductive pathway for the electron emission, reducing or minimizing heat transfer to maintain a nano-scale heat engine, and preventing arcing.

With respect to thermionic converters, the electrical efficiency of exemplary embodiments of these devices depends on low work function materials deposited on the emitter electrode (cathode) and the collector electrode (anode). The efficiency of two low work function value electrodes can be increased by developing cathodes with sufficient thermionic emission of electrons operating even at room temperature. These low work function cathodes and anodes provide copious amounts of electrons. Similarly, a tunneling device includes two low work function electrodes separated by a designed nano-fluid. Cooling by electrode emission refers to the transport of hot electrons across the nano-fluid gap, from the object to be cooled (cathode) to the heat rejection electrode (anode). Thus, exemplary embodiments involve coupling of several technologies, including: the electrospray-deposited two low work function electrodes including, for example, cesium-oxide on both electrode surfaces; an energy selective electron-transfer thermionic emission and quantum hopping of electrons; a nano-fluid that is tailored as a thermoelectric element to conduct electricity while minimizing heat transfer within the device; and thermal communication from the anode electrical connection that is in thermal contact with the device and the heat dissipating device, such as a heat sink or a heat exchanger, produces a thermionic power generator according to an exemplary embodiment.

The thermal energy harvesting thermionic devices of exemplary embodiments described herein facilitate generating electrical energy via a long-lived, constantly-recharging, battery-like device for any size-scale electrical application. Thermal energy harvesting thermionic devices of exemplary embodiments have a conversion efficiency superior to presently available single and double conventional batteries. In addition, the devices of exemplary embodiments described herein may be incorporated into an apparatus for charging a secondary battery and/or powering an electrical load, such as a power-consumption device. The thermal energy harvesting thermionic devices of exemplary embodiments described herein are light weight, compact, and have a relatively long operating life with an electrical power output at a useful value. Furthermore, in addition to the tailored work functions, the nanoparticle clusters of exemplary embodiments described herein are multiphase nano-composites that include thermoelectric materials. The combination of thermoelectric and thermionic functions within a single device further enhances the power generation capabilities of the thermal energy harvesting thermionic devices.

The conversion of heat from an appliance into usable electricity enables energy harvesting capable of offsetting, or even replacing, the reliance of electronics and appliances on conventional power supplies, such as electrochemical batteries, especially when long-term operation of a large number of electronic devices in dispersed locations is required. Energy harvesting distinguishes itself from batteries and hardwire power owing to inherent advantages, such as outstanding longevity measured in years, little maintenance, and minimal disposal and contamination issues. The thermal energy harvesting thermionic devices described herein demonstrate a novel electric generator with low cost for efficiently harvesting thermal energy. The devices described herein initiate electron flow due to the differences in the Fermi levels of the electrodes without the need for an initial temperature differential or thermal gradient, although in exemplary embodiments appliances are used to generate the temperature differentials over the course of use.

The thermal energy harvesting thermionic devices of exemplary embodiments described herein are scalable across a large number of power generation requirements. The devices may be designed for applications requiring electric power in the milliwatts (mW), watts (W), kilowatts (kW), and megawatts (MW) ranges.

The production of renewable, sustainable, green energy resources is the critical innovation for sustainable development of human civilization. Embodiments disclosed herein include one or more thermal energy harvesting thermionic devices operating proximal to an appliance to power electricity-consuming devices, including but not limited to the appliance. Further embodiments disclosed herein include one or more thermal energy harvesting thermionic devices operating proximal to an appliance to complement the power of a battery or other electricity-generating system (e.g., an electrical outlet of an AC source) to power electricity-consuming devices, including but not limited to the appliance. In exemplary embodiments, the thermionic device is a nanoscale energy harvester, and in further exemplary devices is the sole power supply. In an exemplary embodiment, the thermionic device can cause the appliance to be substantially autogenous or self-powered, converting heat generated by the appliance into electricity for further operation of the appliance.

Aspects of the present embodiments are described herein with reference to one or more of flowchart illustrations and/or block diagrams of methods and apparatus (systems) according to the embodiments.

While particular embodiments have been shown and described, it will be understood to those skilled in the art that, based upon the teachings herein, changes and modifications may be made without departing from its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to the embodiments containing only one such element, even when the same claim includes the introductory phrases “one or more” or “at least one” and indefinite articles such as “a” or “an”; the same holds true for the use in the claims of definite articles. As used herein, the term “and/or” means either or both (or any combination or all of the terms or expressed referred to).

The corresponding structures, materials, acts, and equivalents of all means or step plus function elements in the claims below are intended to include any structure, material, or act for performing the function in combination with other claimed elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiments were chosen and described in order to best explain the principles of the embodiments and the practical application, and to enable others of ordinary skill in the art to understand the embodiments for various embodiments with various modifications and combinations with one another as are suited to the particular use contemplated. Accordingly, the scope of protection of the embodiment(s) is limited only by the following claims and their equivalents.

What is claimed is:

1. A system comprising:
an appliance adapted to generate thermal energy;
a thermal energy harvesting thermionic device positioned proximal to the appliance, the thermal energy harvesting thermionic device to receive the thermal energy from the appliance and generate an electrical output, the thermal energy harvesting thermionic device comprising:
a cathode;
an anode spaced from the cathode; and
a plurality of nanoparticles in a medium contained in the space between the cathode and the anode, the nanoparticles configured to permit electron transfer between the cathode and the anode;
an electrical conductive path configured to transfer electrical output from the thermal energy harvesting thermionic device to a load; and
a heat-dissipating device positioned to reduce a temperature of the electrical conductive path by thermal exchange.

2. The system of claim 1, wherein the heat-dissipating device comprises one or more fins along the electrical conductive path.

3. The system of claim 1, wherein the appliance is operatively connected to the thermal energy harvesting thermionic device to receive the electrical output from the thermal energy harvesting thermionic device for powering the appliance.

4. The system of claim 1, wherein the thermal energy harvesting thermionic device comprises a plurality of serially connected thermal energy harvesting thermionic devices.

5. The system of claim 1, wherein the cathode, the anode, and/or the space between the cathode and the anode has a nano-scale thickness.

6. The system of claim 5, wherein the nano-scale thickness is in a range of 2 nm to 10 nm.

7. A method, comprising:
providing the system of claim 1;
operating the appliance to generate the thermal energy;
transferring the thermal energy from the appliance to the thermal energy harvesting thermionic device and generating the electrical output; and
reducing the temperature of the electrical conductive path using the heat dissipating device.

8. A system comprising:
an appliance comprising a housing and a heat source contained within the housing, the heat source adapted to generate thermal energy;
a thermal energy harvesting thermionic device positioned within the housing of the appliance, the thermal energy harvesting thermionic device to receive the thermal energy from the appliance and generate an electrical output, the thermal energy harvesting thermionic device comprising:
a cathode;
an anode spaced from the cathode; and
a plurality of nanoparticles in a medium contained in the space between the cathode and the anode, the nanoparticles configured to permit electron transfer between the cathode and the anode;
an electrical conductive path configured to transfer electrical output from the thermal energy harvesting thermionic device to the appliance for powering the appliance;
a heat-dissipating device positioned to reduce a temperature of the electrical conductive path by thermal exchange.

9. The system of claim 8, wherein the heat dissipating device comprises one or more fins along the electrical conductive path.

10. The system of claim 8, wherein the thermal energy harvesting thermionic device comprises a plurality of serially connected thermal energy harvesting thermionic devices.

11. The system of claim 8, wherein the cathode, the anode, and/or the space between the cathode and the anode has a nano-scale thickness.

12. The system of claim 11, wherein the nano-scale thickness is in a range of 2 nm to 10 nm.

13. A method, comprising:
providing the system of claim 8;
operating the appliance to generate the thermal energy;
transferring the thermal energy from the appliance to the thermal energy harvesting thermionic device and generating the electrical output;
powering the appliance with the electrical output from the thermal energy harvesting thermionic device; and
reducing the temperature of the electrical conductive path using the heat-dissipating device.

14. A portable apparatus comprising:
a portable housing comprising a body having at least one male electrical coupling member and at least one female electrical coupling member;
an electrical energy storage device contained in the housing;
a heat generating source contained in the housing and operatively connected to the electrical energy storage device to convert electrical energy supplied by the electrical energy storage device to heat;
a thermal energy harvesting thermionic device contained in the housing proximal to the heat generating source to receive the heat from the heat generating source, the thermal energy harvesting thermionic device adapted to generate an electrical output, the thermal energy harvesting thermionic device comprising:
a cathode;
an anode spaced from the cathode; and
a plurality of nanoparticles in a medium contained in the space between the cathode and the anode, the nanoparticles configured to permit electron transfer between the cathode and the anode.

15. The portable apparatus of claim 14, wherein the at least one male electrical coupling member comprises an AC outlet compatible plug, and wherein the at least one female electrical coupling member comprise an AC outlet contact receptacle.

16. The portable apparatus of claim 14, wherein the cathode, the anode, and/or the space between the cathode and the anode has a nano-scale thickness.

17. The portable apparatus of claim 16, wherein the nano-scale thickness is in a range of 2 nm to 10 nm.

18. The portable apparatus of claim 14, wherein the electrical energy storage device comprises a capacitor.

19. The portable apparatus of claim 14, wherein the heat generating source comprises a resistor.

20. A method comprising:
providing the portable apparatus of claim 14;
electrically coupling the at least one male electrical coupling member of the portable charger to an electrical power source and charging the electrical energy storage device of the portable charger;
electrically uncoupling the at least one male electrical coupling member of the portable apparatus from the electrical power source;
electrically coupling the at least one female electrical coupling member of the portable apparatus to an appliance;
supplying electrical energy from the electrical energy storage device to the heat generating source to generate heat;
transmitting the generated heat to the thermal energy harvesting thermionic device and generating electrical output from the thermal energy harvesting thermionic device; and
supplying the electrical output to the appliance electrically coupled to the at least one female electrical coupling member of the portable apparatus to power the appliance.
